(19) United States
(12) Patent Application Publication
(10) Pub. No.: US 2026/0135299 A1
(43) Pub. Date: May 14, 2026

(54) Wireless Circuitry with Antenna Offset Mitigation

(71) Applicant: Apple Inc., Cupertino, CA (US)

(72) Inventors: Xiaofang Mu, San Jose, CA (US); Behzad Tavassoli Hozouri, Sunnyvale, CA (US); Jorge L. Rivera Espinoza, Los Gatos, CA (US); Xiaojie Fu, San Jose, CA (US); Bernd W. Adler, Triboltingen (CH); Lei Feng, San Jose, CA (US)

(21) Appl. No.: 19/380,771

(22) Filed: Nov. 5, 2025

Related U.S. Application Data
(60) Provisional application No. 63/718,229, filed on Nov. 8, 2024.

(51) Int. Cl. H01Q 5/40; H01Q 3/34

(52) U.S. Cl. CPC H01Q 5/40; H01Q 3/34

(57) ABSTRACT

A communications system may include first and second devices. A first antenna on the first device and a second antenna on the second device may form a wireless data connector that transfers data at high data rates between the first and second devices while the devices are in close proximity to each other. Structures and techniques are provided that help to mitigate the effect of non-zero offsets between the first and second antennas. For example, each antenna may include a set of antenna elements that are arranged in a pattern that is symmetric about four different axes. The antenna elements may concurrently convey the same radio-frequency signal at four different phases. Each antenna element may be provided with antenna structures that tilt the radiation pattern of the antenna element such that the antenna element exhibits peak realized gain at angles off of boresight.

This application claims the benefit of U.S. Provisional Patent Application No. 63/718,229, filed Nov. 8, 2024, which is hereby incorporated by reference herein in its entirety.

### FIELD

This disclosure relates generally to wireless communications, including wireless communications performed by electronic devices.

### BACKGROUND

Communications systems can include electronic devices with wireless circuitry. The wireless circuitry includes antennas that convey radio-frequency signals.

In some situations, an antenna on a first electronic device is used to convey radio-frequency signals with an antenna on a second electronic device in close proximity to the first electronic device. If care is not taken, misalignment between antennas on electronic devices in close proximity to each other can limit wireless performance levels for one or both devices.

### SUMMARY

A communications system may include a first device and a second device. The first device may include a first antenna and the second device may include a second antenna. The first and second antennas may form a wireless data connector that transfers wireless data at high data rates between the first and second devices while the devices are in close proximity to each other. Structures and techniques are provided to help mitigate the effect of a non-zero offset between the first and second antennas on wireless data transfer performance.

For example, each antenna may include a set of antenna elements. The antenna elements may be arranged in a rectangular grid pattern on a substrate at orientations that configure the antenna to exhibit symmetry about four linear axes. The antenna elements may include, for example, first and second antenna elements arranged along a first axis and third and fourth antenna elements arranged along a second axis parallel to the first axis. The first and third antenna elements may be arranged along a third axis orthogonal to the first axis. The second and fourth antenna elements may be arranged along a fourth axis parallel to the third axis. The antenna elements may be rotated such that lateral edges of the antenna elements are oriented at non-parallel (e.g., 45 degree) angles with respect to the first, second, third, and fourth axes.

As another example, the second antenna element may convey a radio-frequency signal with a first phase. The third antenna element may concurrently convey the radio-frequency signal with a second phase that is 180 degrees less than the first phase. The first antenna element may concurrently convey the radio-frequency signal with a third phase that is greater than the first phase by a phase shift. The fourth antenna element may concurrently convey the radio-frequency signal with a fourth phase that is greater than the second phase by the phase shift. The phase shift may have a magnitude equal to 90 degrees, for example. If desired, each antenna element may be provided with antenna structures that tilt the radiation pattern of the antenna element such that the antenna element exhibits peak realized gain at angles off of boresight. These techniques may serve to increase the effective electrical area of the antenna and/or to widen the radiation pattern of the antenna in a manner that helps to mitigate the effect of offsets between the first and second antennas on wireless data transfer between the first and second devices.

An aspect of the disclosure provides wireless circuitry. The wireless circuitry can include a transceiver configured to convey a signal. The wireless circuitry can include a first antenna element communicatively coupled to the transceiver. The wireless circuitry can include a second antenna element communicatively coupled to the transceiver. The first antenna element can be configured to convey the signal at a first phase. The second antenna element can be configured to convey the signal at a second phase that is 180 degrees less than the first phase concurrent with the first antenna element conveying the signal.

An aspect of the disclosure provides an antenna. The antenna can include a substrate. The antenna can include fences of conductive vias extending through the substrate and laterally surrounding first, second, third, and fourth cavities. The antenna can include first, second, third, and fourth antenna elements on the substrate within the first, second, third, and fourth cavities, respectively. A first linear axis can extend through central axes of the first and second antenna elements. A second linear axis parallel to the first linear axis can extend through central axes of the third and fourth antenna elements. A third linear axis orthogonal to the first linear axis can extend through the central axes of the first and third antenna elements. A fourth linear axis parallel to the third linear axis can extend through the central axes of the second and fourth antenna elements. The first, second, third, and fourth antenna elements can have respective first and second edges extending parallel to a fifth linear axis extending through the central axes of the first and fourth antenna elements. The first, second, third, and fourth antenna elements can have respective third and fourth edges extending parallel to a sixth linear axis extending through the central axes of the second and third antenna elements.

An aspect of the disclosure provides an electronic device. The electronic device can include a housing having a dielectric wall. The electronic device can include a coil in the housing and configured to convey near-field communications (NFC) signals through the dielectric wall. The electronic device can include a set of one or more magnets disposed around a periphery of the coil and configured to attract an external device through the dielectric wall. The electronic device can include an antenna that includes first, second, third, and fourth antenna elements configured to concurrently convey a radio-frequency signal with the external device through the dielectric wall. The first antenna element can be configured to convey the radio-frequency signal with a first phase. The second antenna element can be configured to convey the radio-frequency signal with a second phase that is 180 degrees less than the first phase. The third antenna element can be configured to convey the radio-frequency signal with a third phase that is greater than the first phase by a phase shift. The fourth antenna element can be configured to convey the radio-frequency signal with a fourth phase that is greater than the second phase by the phase shift.

### BRIEF DESCRIPTION OF THE DRAWINGS

FIG. 1 is a schematic diagram of an illustrative communications system including two electronic devices that communicate with each other using antennas in accordance with some embodiments.

FIG. 2 is a perspective view of an illustrative electronic device that includes an antenna for conveying radio-frequency signals through a housing wall in accordance with some embodiments.

FIG. 3 is a cross-sectional side view showing how two illustrative electronic devices may convey wireless data while antennas on the electronic devices are aligned in accordance with some embodiments.

FIG. 4 is a cross-sectional side view showing how two illustrative electronic devices may convey wireless data while antennas on the electronic devices are misaligned in accordance with some embodiments.

FIG. 5 is a schematic diagram showing how an illustrative antenna may be fed by a radio-frequency transmission line in accordance with some embodiments.

FIG. 6 is a circuit diagram of an illustrative antenna having multiple antenna elements that convey different phases of a differential signal in accordance with some embodiments.

FIG. 7 is a circuit diagram of an illustrative antenna having multiple antenna elements that convey different phases of a single-ended signal in accordance with some embodiments.

FIG. 8 is a top view of an illustrative antenna having four axisymmetric oriented antenna elements in accordance with some embodiments.

FIG. 9 is a top view of different radiation patterns exhibited by an illustrative antenna of the type shown in FIG. 8 under different feeding conditions in accordance with some embodiments.

FIG. 10 is a cross-sectional side view showing how an illustrative antenna may be configured to exhibit a tilted radiation pattern in accordance with some embodiments.

FIG. 11 is a cross-sectional side view of an illustrative antenna element in accordance with some embodiments.

FIG. 12 is an exploded top view of two conductive layers in an illustrative antenna element of the type shown in FIG. 11 in accordance with some embodiments.

### DETAILED DESCRIPTION

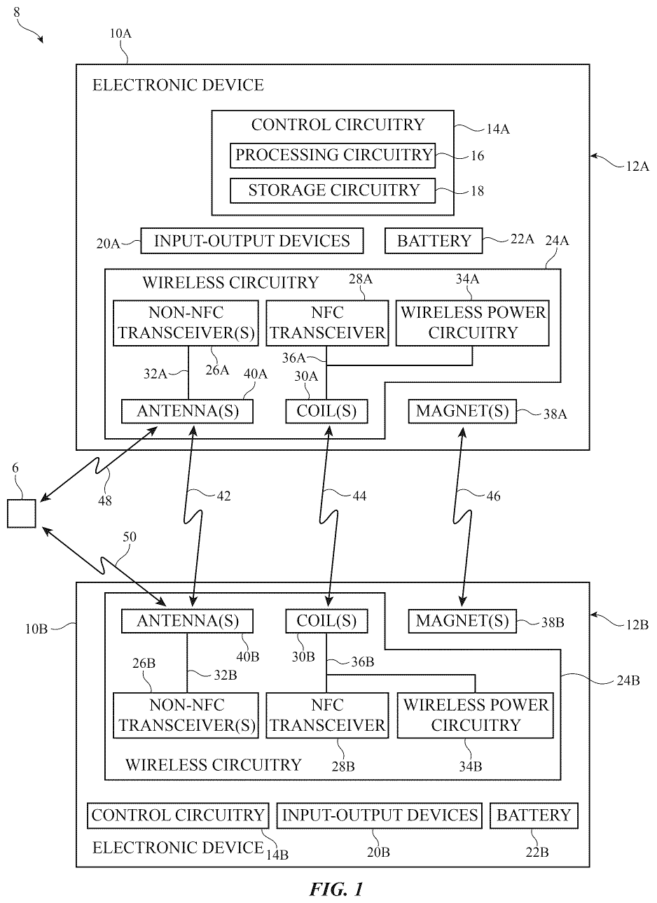

FIG. 1 is a diagram of an illustrative communications system 8. Communications system 8 (sometimes referred to herein as communications network 8, network 8, or system 8) includes a set of user equipment (UE) devices such as devices 10. Devices 10 may include at least a first device 10A and a second device 10B that wirelessly communicate with each other. Communications system 8 may also include external communications equipment 6. External communications equipment 6 may form part of a wireless network such as a wireless local area network (WLAN), a wireless personal area network (WPAN), a peer-to-peer (P2P) network, a device-to-device (D2D) network, or a cellular telephone network, as examples. External communications equipment 6 may include one or more cellular base stations, one or more wireless access points, communications satellites, other devices such as device 10, etc.

Device 10A and device 10B may be any desired electronic devices. Device 10A and/or device 10B may be, for example, a laptop computer, a desktop computer, a computer monitor containing an embedded computer, a tablet computer, a cellular telephone, a media player, or other handheld or portable electronic device, a smaller device such as a wristwatch device, a pendant device, an accessory device such as wireless headphones, a wireless earbud/earpiece, gaming controller, or user input device (e.g., a mouse, keyboard, pointing device, etc.), a head-mounted device such as goggles, eyeglasses, a helmet, or other equipment worn on a user's head (e.g., an augmented, virtual, or mixed reality head-mounted display device), or another wearable or miniature device, a television, a computer display device that does or does not contain an embedded computer, a gaming device (e.g., a video gaming console), a video streaming or playback device, a video transmitting device, a camera, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, an accessory such as a removable device case (e.g., a removable device case configured to power/charge another electronic device, a removable device case having wireless communications capabilities, etc.), equipment that implements the functionality of two or more of these devices, or other electronic equipment.

Device 10B may be the same type of device as device 10A or may be a different type of device than device 10A. In one implementation that is sometimes described herein as an example, device 10A may be a cellular telephone or tablet computer and device 10B may be a removable device case for the cellular telephone or tablet computer (e.g., a removable battery case or protective case). In other possible implementations, device 10A and device 10B may both be cellular telephones or tablet computers, device 10A may be a cellular telephone and device 10B may be a tablet computer, device 10B may be a cellular telephone and device 10A may be a tablet computer, device 10A may be a cellular telephone or tablet computer and device 10B may be a wireless device integrated into a vehicle, etc. These examples are illustrative and non-limiting and, in general, devices 10A and 10B may be any desired types of devices.

Device 10A may include a housing such as housing 12A. Device 10B may include a housing such as housing 12B. Housings 12A and 12B, which are sometimes also referred to as cases or enclosures, may each be formed from plastic, glass, ceramics, fiber composites, metal (e.g., stainless steel, aluminum, titanium, etc.), other suitable materials, or a combination of these materials. In some situations, parts of housings 12A and/or 12B may be formed from dielectric or other low-conductivity material (e.g., glass, ceramic, plastic, sapphire, etc.). In other situations, housings 12A and/or 12B or at least some of the structures that make up the housings may be formed from metal elements.

Device 10A may include control circuitry such as control circuitry 14A. Control circuitry 14A may include storage such as storage circuitry 18. Storage circuitry 18 may include hard disk drive storage, nonvolatile memory (e.g., flash memory or other electrically-programmable-read-only memory configured to form a solid-state drive), volatile memory (e.g., static or dynamic random-access-memory), etc. Control circuitry 14A may also include processing circuitry such as processing circuitry 16. Processing circuitry 16 may be used to control the operation of device 10A. Processing circuitry 16 may include on one or more processors such as microprocessors, microcontrollers, digital signal processors, host processors, baseband processor integrated circuits, application specific integrated circuits, central processing units (CPUs), graphics processing units (GPUs), etc. Control circuitry 14A may be configured to perform operations in device 10A using hardware (e.g., dedicated hardware or circuitry), firmware, and/or software. Software code for performing operations in device 10A may be stored on storage circuitry 18 (e.g., storage circuitry 18 may include non-transitory (tangible) computer readable storage media that stores the software code). The software code may sometimes be referred to as program instructions, software, data, instructions, or code. Software code stored on storage circuitry 18 may be executed by processing circuitry 16.

Device 10B may include control circuitry such as control circuitry 14B. Control circuitry 14B may include processing circuitry (see, e.g., processing circuitry 16 on device 10A) and may include storage circuitry (see, e.g., storage circuitry 18 on device 10A). Control circuitry 14B may be configured to perform operations in device 10B using hardware (e.g., dedicated hardware or circuitry), firmware, and/or software. Control circuitry 14B on device 10B may include the same storage and/or processing resources as control circuitry 14A on device 10B or may include a different amount of storage and/or processing resources than control circuitry 14 on device 10B.

Control circuitry 14A may be used to run software on device 10A. Control circuitry 14B may be used to run software on device 10B. Software executed by control circuitry 14A and/or 14B may include, for example, internet browsing applications, data transfer applications (e.g., applications that support wired data transfer over a wired link such as a universal serial bus (USB) link with an external device and/or that support wireless data transfer with the external device over a wireless link), voice-over-internet-protocol (VOIP) telephone call applications, messaging applications, social media applications, word processing applications, spreadsheet applications, office applications, productivity applications, email applications, media playback applications, gaming applications, virtual, augmented, or mixed reality applications, navigation or mapping applications, operating system functions, etc. Execution of one or more of these applications may involve the transmission of wireless data to another device and/or to external communications equipment 6.

To support wireless communications with external equipment, control circuitry 14A and control circuitry 14B may be used in implementing wireless communications protocols. Communications protocols that may be implemented using control circuitry 14A and control circuitry 14B include internet protocols, wireless local area network (WLAN) protocols (e.g., IEEE 802.11 protocols—sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 3GPP Fifth Generation (5G) New Radio (NR) protocols, Sixth Generation (6G) protocols, sub-THz protocols, THz protocols, etc.), antenna diversity protocols, satellite navigation system protocols (e.g., global positioning system (GPS) protocols, global navigation satellite system (GLONASS) protocols, Baidu protocols, Galileo protocols, etc.), antenna-based spatial ranging protocols (e.g., radio detection and ranging (RADAR) protocols or other desired range detection protocols for signals conveyed at millimeter and centimeter wave frequencies), satellite communications protocols, wireless charging (power transfer) protocols, short range communications link protocols (e.g., wireless data transfer protocols that support in-band full duplex communications), etc. Each communication protocol may be associated with a corresponding radio access technology (RAT) that specifies the physical connection methodology used in implementing the protocol.

Device 10A may include input-output (I/O) devices 20A. Device 10B may include input-output devices 20B. Input-output devices 20A and/or 20B may include one or more displays that display images or video (e.g., touch sensitive displays or displays without touch sensitivity), sensors such as light sensors, image sensors (e.g., one or more cameras), infrared sensors, light detection and ranging (lidar) sensors, gyroscopes, accelerometers or other components that can detect motion and device orientation relative to the Earth, capacitance sensors, proximity sensors (e.g., a capacitive proximity sensor and/or an infrared proximity sensor), magnetic sensors, and/or other sensors, user interface devices, data port devices, buttons, joysticks, scrolling wheels, touch pads, keypads, keyboards, microphones, cameras, speakers, status indicators, light sources, audio jacks and other audio port components, digital data port devices, USB ports, and/or other input-output components. If desired, device 10B may include fewer input-output devices than device 10A or vice versa.

Device 10A may include wireless circuitry 24A to support wireless communications and/or wireless power transfer between device 10A and external equipment (e.g., external communications equipment 6 and/or device 10B). Wireless circuitry 24A may include a set of one or more antennas 40A and one or more non-near-field coupling (non-NFC) transceivers 26A (sometimes also referred to herein as radios 26A or modems 26A). Device 10B may include wireless circuitry 24B to support wireless communications and/or wireless power transfer between device 10B and external equipment (e.g., external communications equipment 6 and/or device 10A). Wireless circuitry 24B may include a set of one or more antennas 40B and one or more non-NFC transceivers 26B (sometimes also referred to herein as radios 26B or modems 26B).

Each non-NFC transceiver 26A and 26B may include a transmitter that transmits radio-frequency signals, a receiver that receives radio-frequency signals, or both a transmitter and a receiver. Each non-NFC transceiver 26A may convey radio-frequency signals in non-NFC bands over one or more antennas 40A and each non-NFC transceiver 26B may convey radio-frequency signals in non-NFC bands using one or more non-NFC communications protocols (e.g., communications protocols that support carrier frequencies greater than or equal to around 600 MHz). Antenna(s) 40A and 40B may convey radio-frequency signals that carry wireless data via propagation in the electromagnetic far-field domain and/or, if desired, in the electromagnetic near-field domain. From the perspective of device 10A, antenna(s) 40B are sometimes referred to herein as external antenna(s) 40B and device 10B is sometimes referred to herein as external device 10B. From the perspective of device 10B, antenna(s) 40A are sometimes referred to herein as external antenna(s) 40A and device 10A is sometimes referred to herein as external device 10A.

If desired, non-NFC transceiver(s) 26A may convey radio-frequency signals 42 with non-NFC transceiver(s) 26B on device 10B over-the-air using antenna(s) 40A and antenna(s) 40B. Radio-frequency signals 42 may propagate in a non-NFC frequency band according to a non-NFC protocol (e.g., a wireless data transfer protocol, a WPAN protocol, a WLAN protocol, a cellular telephone protocol, a D2D protocol, an ultra-low latency audio protocol, etc.). Radio-frequency signals 42 are therefore sometimes referred to herein as non-NFC signals 42. Radio-frequency signals 42 may carry wireless data. The wireless data may be organized into a stream or series of data bits, symbols, frames, packets, datagrams, and/or other structures. In some implementations that are described herein as an example, devices 10A and 10B may convey radio-frequency signals 42 using a wireless data transfer protocol (e.g., to support high speed wireless data transfer between device 10A and device 10B while device 10B is in close proximity to device 10A).

If desired, non-NFC transceiver(s) 26A may convey radio-frequency signals 48 with external communication equipment 6 using antenna(s) 40A and/or non-NFC transceiver(s) 26B may convey radio-frequency signals 50 with external communication equipment 6 over-the-air using antenna(s) 40B. Radio-frequency signals 48 and 50 may propagate in one or more non-NFC frequency bands according to one or more non-NFC protocol (e.g., a WPAN protocol, a WLAN protocol, a cellular telephone protocol, a D2D protocol, an ultra-low latency audio protocol, etc.). Radio-frequency signals 48 and radio-frequency signals 50 are therefore sometimes also referred to herein as non-NFC signals 48 and 50. Radio-frequency signals 48 and 50 may carry wireless data. The wireless data may be organized into a stream or series of data bits, symbols, frames, packets, datagrams, and/or other structures.

If desired, device 10A may use different antennas 40A to convey radio-frequency signals 48 with external communications equipment 6 and to convey radio-frequency signals 42 with device 10B. Alternatively, device 10A may use one or more of the same antennas 40A to convey radio-frequency signals 48 with external communications equipment 6 and to convey radio-frequency signals 42 with device 10B. Similarly, if desired, device 10B may use different antennas 40B to convey radio-frequency 50 with external communications equipment 6 and to convey radio-frequency signals 42 with device 10A. Alternatively, device 10B may use one or more of the same antennas 40B to convey radio-frequency signals 50 with external communications equipment 6 and to convey radio-frequency signals 42 with device 10A.

If desired, wireless circuitry 24A may also include one or more coils 30A and a corresponding near-field communications (NFC) transceiver 28A and/or wireless circuitry 24B may include one or more coils 30B and a corresponding NFC transceiver 28B. NFC transceivers 28A and 28B may each include a transmitter that transmits radio-frequency signals, a receiver that receives radio-frequency signals, or both a transmitter and a receiver. NFC transceiver 28A may convey radio-frequency signals in an NFC band (e.g., at 13.56 MHz) using coil(s) 30A and an NFC communications protocol and/or NFC transceiver 28B may convey radio-frequency signals in the NFC band using coil(s) 30B and the NFC communications protocol.

When coil(s) 30B in device 10B are brought into close proximity with coil(s) 30A in device 10A (e.g., overlapping each other and within 1-10 cm of separation), coil(s) 30A and 30B may convey radio-frequency signals 44 that carry wireless data via electromagnetic near-field coupling and/or propagation in the electromagnetic near-field domain. The wireless data may be organized into a stream or series of data bits, symbols, frames, packets, datagrams, and/or other structures. Radio-frequency signals 44 propagate at frequencies in an NFC band (e.g., at 13.56 MHz) according to the NFC communications protocol and are sometimes also referred to herein as NFC signals 44.

Each non-NFC transceiver 26A, non-NFC transceiver 26B, NFC transceiver 28A, and NFC transceiver 28B may include circuitry that operates on signals at baseband frequencies (e.g., baseband processing circuitry, one or more baseband processors, etc.), signal generator circuitry, modulation/demodulation circuitry (e.g., one or more modems), radio-frequency transmitter circuitry, radio-frequency receiver circuitry, mixer circuitry for downconverting radio-frequency signals to baseband frequencies or intermediate frequencies between radio and baseband frequencies and/or for upconverting signals at baseband or intermediate frequencies to radio-frequencies, amplifier circuitry (e.g., one or more power amplifiers and/or one or more low-noise amplifiers (LNAs)), analog-to-digital converter (ADC) circuitry, digital-to-analog converter (DAC) circuitry, control paths, power supply paths, signal paths (e.g., radio-frequency transmission lines, intermediate frequency transmission lines, baseband signal lines, etc.), switching circuitry, filter circuitry, inverters, power converters (e.g., DC-to-DC converters), single-ended signal to differential signal conversion circuitry (e.g., one or more baluns), radio-frequency transformers, and/or any other circuitry for transmitting and/or receiving radio-frequency signals using antenna(s) 40A/40B and/or coil(s) 30A/30B.

The components of NFC transceiver 28A and each non-NFC transceiver 26A may be mounted onto a respective substrate or integrated into a respective integrated circuit, chip, package, or system-on-chip (SOC) in device 10A. Alternatively, the components of multiple non-NFC transceivers 26A and/or NFC transceiver 28A may share a single substrate, integrated circuit, chip, package, or SOC in device 10. Similarly, the components of NFC transceiver 28B and each non-NFC transceiver 26B may be mounted onto a respective substrate or integrated into a respective integrated circuit, chip, package, or SOC in device 10B. Alternatively, the components of multiple non-NFC transceivers 26B and/or NFC transceiver 28B may share a single substrate, integrated circuit, chip, package, or SOC in device 10B.

Antenna(s) 40A and 40B may be formed using any desired antenna structures. For example, antenna(s) 40A and 40B may include antennas with resonating elements that are formed from loop antenna structures, patch antenna structures (e.g., stacked patch antenna structures), inverted-F antenna structures, slot antenna structures, planar inverted-F antenna structures, helical antenna structures, monopole antenna structures, dielectric resonating element structures, dipole antenna structures, combinations or hybrids of these structures, etc. If desired, filter circuitry, switching circuitry, impedance matching circuitry, and/or other antenna tuning components may be adjusted to adjust the frequency response and wireless performance of antenna(s) 40A and/or 40B over time. If desired, multiple antennas 40A may be implemented as a phased array antenna on device 10A (e.g., where each antenna forms a radiator or antenna element of the phased array antenna, which is sometimes also referred to as a phased antenna array) and/or multiple antennas 40B may be implemented as a phased array antenna on device 10B. In these scenarios, each phased array antenna may convey radio-frequency signals within a corresponding signal beam. The phases and/or magnitudes of each radiator in the phased array antenna may be adjusted so the radio-frequency signals for each radiator constructively and destructively interfere to steer or orient the signal beam in a particular pointing direction (e.g., a direction of peak signal gain). The signal beam may be adjusted or steered over time.

Coil(s) 30A may include one or more turns or loops of conductive traces, wire, or other conductive material in device 10A. If desired, coil(s) 30A may be disposed on, overlapping, and/or around one or more ferrite cores to optimize electromagnetic coupling between coil(s) 30A and coil(s) 30B when coil(s) 30B at least partially overlap coil(s) 30A. Similarly, coil(s) 30B may include one or more turns or loops of conductive traces, wire, or other conductive material in device 10B. If desired, coil(s) 30B may be disposed on, overlapping, and/or around one or more ferrite cores to optimize electromagnetic coupling between coil(s) 30B and coil(s) 30A when coil(s) 30A at least partially overlap coil(s) 30B.

Each non-NFC transceiver 26A may convey radio-frequency signals 42 and/or 48 using one or more antennas 40A (e.g., antenna(s) 40A may convey the radio-frequency signals for the non-NFC transceiver(s)). NFC transceiver 28A may convey NFC signals 44 using one or more coils 30A (e.g., coil(s) 30A may convey the NFC signals for the NFC transceiver). Similarly, each non-NFC transceiver 26B may convey radio-frequency signals 42 and/or 50 using one or more antennas 40B (e.g., antenna(s) 40B may convey the radio-frequency signals for the non-NFC transceiver(s)). NFC transceiver 28B may convey NFC signals 44 using one or more coils 30B (e.g., coil(s) 30B may convey the NFC signals for the NFC transceiver).

The term “convey radio-frequency signals” as used herein means the transmission and/or reception of the radio-frequency signals (e.g., for performing unidirectional and/or bidirectional wireless communications with external wireless communications equipment). Antenna(s) 40A and 40B may transmit radio-frequency signals by radiating the radio-frequency signals into free space (or to free space through intervening device structures such as a dielectric cover layer). Antenna(s) 40A and 40B may additionally or alternatively receive radio-frequency signals from free space (e.g., through intervening devices structures such as a dielectric cover layer). The radio-frequency signals need not pass over the air and may, in some situations, pass through the housing of one device and the housing of another device without propagating over the air between the housings. The transmission and reception of radio-frequency signals by antenna(s) 40A and 40B each involve the excitation or resonance of antenna currents on antenna resonating elements in the antenna by the radio-frequency signals within the frequency band(s) of operation of the antennas.

Current on coil(s) 30A may transmit NFC signals 44 to coil(s) 30B in the near-field domain (e.g., by inducing a magnetic field through an opening in coil(s) 30A that induces corresponding current on coil(s) 30B while coil(s) 30B overlap coil(s) 30A). Current can also be induced onto coil(s) 30A by incident NFC signals 44 from coil(s) 30B while coil(s) 30B overlap coil(s) 30A (e.g., coil(s) 30A may receive NFC signals 44 in the near-field domain). Similarly, current on coil(s) 30B may transmit NFC signals 44 to coil(s) 30A in the near-field domain (e.g., by inducing a magnetic field through an opening in coil(s) 30B that induces corresponding current on coil(s) 30A while coil(s) 30A overlap coil(s) 30B). Current can also be induced onto coil(s) 30B by incident NFC signals 44 from coil(s) 30A while coil(s) 30A overlap coil(s) 30B (e.g., coil(s) 30B may receive NFC signals 44 in the near-field domain).

Each non-NFC transceiver 26A on device 10A may be coupled to one or more antennas 40A over one or more radio-frequency transmission line paths 32A. Each non-NFC transceiver 26B on device 10B may be coupled to one or more antennas 40B over one or more radio-frequency transmission line paths 32B. NFC transceiver 28A on device 10A may be coupled to coil(s) 30A over one or more radio-frequency transmission line paths 36A (e.g., a differential signal path). NFC transceiver 28B on device 10B may be coupled to coil(s) 30B over one or more radio-frequency transmission line paths 36B (e.g., a differential signal path).

Radio-frequency transmission line paths 32A, 32B, 36A, and 36B may each include one or more radio-frequency transmission lines such as coaxial cables, microstrip transmission lines, stripline transmission lines, edge-coupled microstrip transmission lines, edge-coupled stripline transmission lines, transmission lines formed from combinations of transmission lines of these types, etc. The radio-frequency transmission lines in radio-frequency transmission line paths 32A, 32B, 36A, and/or 36B may be integrated into rigid and/or flexible printed circuit boards if desired. One or more of the radio-frequency transmission lines in device 10A may be shared between multiple non-NFC transceivers 26A and/or NFC transceiver 28A if desired. One or more of the radio-frequency transmission lines in device 10B may be shared between multiple non-NFC transceivers 26B and/or NFC transceiver 28B if desired. Radio-frequency front end (RFFE) modules (not shown) may be disposed on one or more of the radio-frequency transmission lines. The radio-frequency front end modules may include substrates, integrated circuits, chips, or packages that are separate from the transceiver(s) and may include filter circuitry, switching circuitry, amplifier circuitry, charge pump circuitry, phase shifting circuitry, balun circuitry, transformers, impedance matching circuitry, radio-frequency coupler circuitry, and/or any other desired radio-frequency circuitry for operating on the radio-frequency signals conveyed over the radio-frequency transmission lines.

Transmission lines in radio-frequency transmission line paths 32A, 32B, 36A, and/or 36B may be integrated into rigid and/or flexible printed circuit boards if desired. In some suitable implementations, radio-frequency transmission line paths 32A, 32B, 36A, and/or 36B may include transmission line conductors (e.g., signal conductors and ground conductors) integrated within multilayer laminated structures (e.g., layers of a conductive material such as copper and a dielectric material such as a resin that are laminated together without intervening adhesive). The multilayer laminated structures may, if desired, be folded or bent in multiple dimensions (e.g., two or three dimensions) and may maintain a bent or folded shape after bending (e.g., the multilayer laminated structures may be folded into a particular three-dimensional shape to route around other device components and may be rigid enough to hold its shape after folding without being held in place by stiffeners or other structures). All of the multiple layers of the laminated structures may be batch laminated together (e.g., in a single pressing process) without adhesive (e.g., as opposed to performing multiple pressing processes to laminate multiple layers together with adhesive).

Non-NFC transceiver(s) 26A may use antenna(s) 40A and non-NFC transceiver(s) 26B may use antenna(s) 40B to transmit and/or receive radio-frequency signals within different frequency bands at radio frequencies (sometimes referred to herein as communications bands or simply as a “bands”). The frequency bands handled by non-NFC transceiver(s) 26A and 26B may include satellite communications bands (e.g., the C band, S band, L band, X band, W band, V band, K band, Kₐ band, Kᵤ band, etc.), wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network (WPAN) frequency bands such as the 2.4 GHz Bluetooth® band or other WPAN communications bands, cellular telephone frequency bands (e.g., bands from about 600 MHz to about 5 GHz, 3G bands, 4G LTE bands, 5G New Radio Frequency Range 1(FR1 ) bands below 10 GHz, 5G New Radio Frequency Range 2(FR2 ) bands between 20 and 60 GHz, 6G bands such as sub-THz bands between around 100 GHz and around 10 THz, etc.), other centimeter or millimeter wave frequency bands between 10-300 GHz, other sub-THz or THF bands between around 60 GHz and 10 THz, satellite navigation frequency bands (e.g., a GPS band from 1565 to 1610 MHz, an L1 band, an L2 band, an L3 band, an L4 band, an L5 band, a Global Navigation Satellite System (GLONASS) band, a BeiDou Navigation Satellite System (BDS) band, a Galileo band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, and/or any other desired frequency bands of interest.

NFC transceiver 28A may use coil(s) 30A and NFC transceiver 28B may use coil(s) 30B to transmit and/or receive NFC signals 44 within an NFC frequency band (e.g., at 13.56 MHz) according to an NFC communications protocol (e.g., a radio-frequency identification (RFID) protocol, an ISO/IEC 14443 protocol, an ISO/IEC 18092 protocol, etc.). If desired, wireless circuitry 24A on device 10A may also include wireless power circuitry 34A and/or wireless circuitry 24B on device 10B may include wireless power circuitry 34B. Wireless power circuitry 34A and wireless power circuitry 34B (sometimes also referred to as wireless charging circuitry) may each include wireless power transmitting circuitry and/or wireless power receiving circuitry. In these implementations, the NFC signals 44 conveyed between coil(s) 30A and coil(s) 30B may include wireless power conveyed between wireless power circuitry 34A and wireless power circuitry 34B (e.g., wireless power signals for wirelessly charging and/or powering device 10A or device 10B).

In some implementations (e.g., when device 10B is a wireless power transmitting device such as a removable battery case, a wireless charging puck, or a wireless charging pad), wireless power circuitry 34A includes wireless power receiving circuitry and wireless power circuitry 34B includes wireless power transmitting circuitry. In these implementations, the wireless power transmitting circuitry in wireless power circuitry 34B may include inverters and/or other power transmission circuitry that generates wireless power signals based on a DC voltage from battery 22B and/or power received from an external power source. Device 10B transmits the wireless power signals to coil(s) 30A on device 10A via coil(s) 30B (e.g., in NFC signals 44). The wireless power receiving circuitry in wireless power circuitry 34A may include, for example, one or more rectifiers and/or other circuitry that produce direct current (DC) power based on the wireless power signals received via coil(s) 30A. Wireless power circuitry 34A may use the generated DC power to power one or more components on device 10A and/or to charge a battery 22A on device 10A (e.g., device 10A may be a wirelessly rechargeable device). Battery 22A may power one or more components on device 10A when device 10A is unplugged from an external power source.

In other implementations, (e.g., when device 10A is a wireless power transmitting device such as a removable battery case, a wireless charging puck, or a wireless charging pad), wireless power circuitry 34B includes wireless power receiving circuitry and wireless power circuitry 34A includes wireless power transmitting circuitry. In these implementations, device 10A may use wireless power circuitry 34A and coil(s) 30A to wirelessly charge and/or power device 10B using wireless power signals in NFC signals 44 (e.g., for charging a battery 22B on device 10B). If desired, wireless power circuitry 34A may include both wireless power transmitting circuitry and wireless power receiving circuitry and/or wireless power circuitry 34B may include both wireless power transmitting circuitry and wireless power receiving circuitry.

Wireless power circuitry 34A may be integrated into NFC transceiver 28A or may be separate from NFC transceiver 28A. In some implementations, part of wireless power circuitry 34A may be integrated into NFC transceiver 28A for receiving wireless data transmitted in-band within the wireless power signals received via coil(s) 30A (e.g., by using FSK demodulation, ASK demodulation, or other demodulation schemes to extract a stream of wireless data bits from incident wireless power signals). Similarly, wireless power circuitry 34B may be integrated into NFC transceiver 28B or may be separate from NFC transceiver 28B. In some implementations, part of wireless power circuitry 34B may be integrated into NFC transceiver 28B for receiving wireless data transmitted in-band within the wireless power signals received via coil(s) 30B (e.g., by using FSK demodulation, ASK demodulation, or other demodulation schemes to extract a stream of wireless data bits from incident wireless power signals).

If desired, device 10A may include one or more magnets 38A and/or device 10B may include one or more magnets 38B. When device 10A is brought into proximity of device 10B (e.g., into physical contact with device 10B), magnet(s) 38A may attract magnet(s) 38B and/or magnet(s) 38B may attract magnet(s) 38A via magnetic field 46. Magnets 38A and 38B may help to attach or secure device 10B to device 10A and/or may help to hold device 10A in a desired position and/or orientation relative to device 10B. Magnets 38A and 38B may, for example, hold device 10A to device 10B at an orientation in which coil(s) 30A overlap and are aligned with coil(s) 30B. This may, for example, help to increase the near-field coupling between coils 30A and 30B without requiring a user to manually and precisely place device 10B in alignment with device 10A. Increasing the near-field coupling between coils 30A and 30B may serve to increase the wireless performance of NFC transceivers 28A and 28B in conveying wireless data via NFC signals 44 and/or may serve to increase the efficiency with which wireless power signals in NFC signals 44 are transferred between devices 10A and 10B.

Magnets 38A and 38B may include permanent magnets, ferromagnets, electromagnets, or any other desired magnetically attractive structures. Additionally or alternatively, a portion of housing 12A and/or housing 12B (e.g., a housing sidewall, clip, lip, bezel, chassis, bracket, etc.) may help to mechanically secure device 10B to device 10A in a particular position and/or orientation (e.g., in implementations where device 10B is a removable device case).

The example of FIG. 1 is illustrative and non-limiting. If desired, NFC transceiver 28A, coil(s) 30A, wireless power circuitry 34A, magnet(s) 38A, radio-frequency transmission line path 36A, input-output devices 20A, and/or battery 22A may be omitted from device 10A. If desired, NFC transceiver 28B, coil(s) 30B, wireless power circuitry 34B, magnet(s) 38B, radio-frequency transmission line path 36B, input-output devices 20B, and/or battery 22B may be omitted from device 10B. Device 10A and/or device 10B may forego communication with external communications equipment 6 if desired.

Although control circuitry 14A is shown separately from wireless circuitry 24A and control circuitry 14B is shown separately from wireless circuitry 24B in the example of FIG. 1 for the sake of clarity, wireless circuitry 24A may include processing and/or storage circuitry that forms a part of control circuitry 14A and/or wireless circuitry 24B may include processing and/or storage circuitry that forms a part of control circuitry 14B. As an example, control circuitry 14A may include baseband circuitry or other control components that form a part of wireless circuitry 24A (e.g., non-NFC transceiver(s) 26A and/or NFC transceiver 28A). The baseband circuitry may, for example, access a communication protocol stack on control circuitry 14A (e.g., storage circuitry 18) to: perform user plane functions at a PHY layer, MAC layer, RLC layer, PDCP layer, SDAP layer, and/or PDU layer, and/or to perform control plane functions at the PHY layer, MAC layer, RLC layer, PDCP layer, RRC, layer, and/or non-access stratum layer.

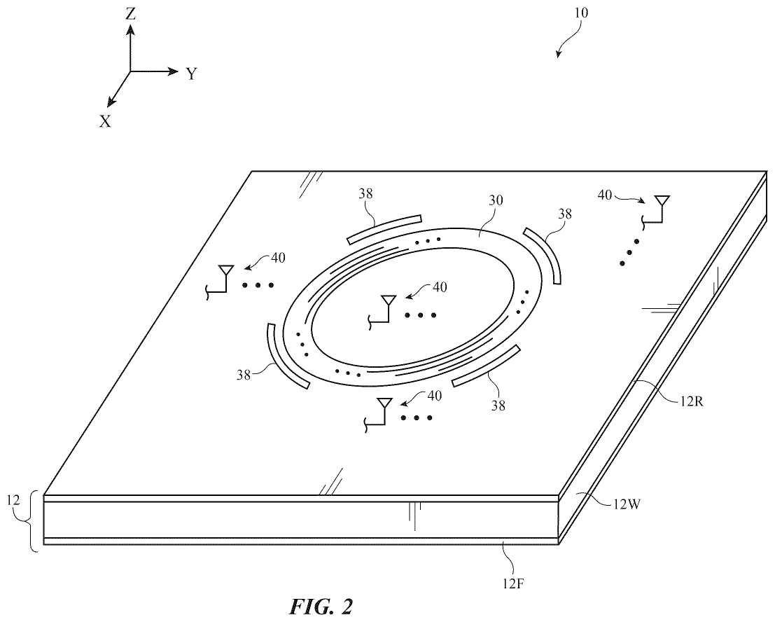

In some implementations that are described herein as an example, the antennas, coils, and/or magnets on device 10A and/or device 10B may operate through the same housing wall or side of device 10A and/or device 10B. FIG. 2 is a rear perspective view showing one example of a device 10 that includes an antenna, a coil, and a magnet that operate through the same housing wall or side of the device.

As shown in FIG. 2, device 10 (e.g., device 10A or device 10B of FIG. 1) may include a coil 30 (e.g., coil 30A or coil 30B of FIG. 1), a set of one or more antennas 40 (e.g., antennas 40A or antennas 40B of FIG. 1), a set of one or more magnets 38 (e.g., magnets 38A or 38B in FIG. 1), and a housing 12 (e.g., housing 12A or housing 12B of FIG. 1). Housing 12 may include a first housing wall 12F at a first (e.g., front) face of device 10, a second housing wall 12R at a second (e.g., rear) face of device 10 opposite the first face, and peripheral sidewalls 12W that extend from housing wall 12F to housing wall 12R and around the lateral periphery of device 10. Housing wall 12F is sometimes also referred to herein as front housing wall 12F of device 10. Housing wall 12R is sometimes also referred to herein as rear housing wall 12R of device 10. In the example of FIG. 2, housing 12 has a substantially rectangular shape. This is illustrative and non-limiting. If desired, housing 12 may have rounded corners, a substantially cylindrical shape, a circular shape, a spherical shape, and/or any other desired shape having any desired number of straight and/or curved housing walls.

Housing walls 12R and 12F may be formed from any desired materials. As one example, device 10 may include a display mounted to the front face of device 10 (e.g., in implementations where device 10 is a cellular telephone, tablet computer, laptop computer, wristwatch, or another type of device having a display screen). In this example, front housing wall 12F may be formed from a substantially transparent cover layer for the display (e.g., a glass, plastic, ceramic, crystal, or sapphire cover layer that transmits light emitted by the display for view by a user). Rear housing wall 12R may be formed from dielectric material such as plastic, glass, sapphire, crystal, ceramic, etc. As another example, device 10 may include a recess or cavity at its front face (e.g., defined by front housing wall 12F and/or other housing structures mounted to front housing wall 12F) that receives another device 10 (e.g., in implementations where device 10 is a removable device case such as a removable battery case). Peripheral sidewalls 12W may be formed from metal and/or dielectric materials. These examples are illustrative and non-limiting. Devices 10A and 10B may each have any desired form factor and may each be any desired type of device. Rear housing wall 12R may be replaced with any desired dielectric housing wall, display cover layer, and/or dielectric cover layer in device 10.

As shown in FIG. 2, coil 30, magnet(s) 38, and antenna(s) 40 may be disposed within the interior of housing 12 and may overlap rear housing wall 12R (e.g., rear housing wall 12R is illustrated in transparency in FIG. 2 for the sake of clarity). Alternatively, one or more of coil 30, magnet(s) 38, and antenna(s) 40 may be mounted to rear housing wall 12R at the exterior of device 10.

Coil 30 may include one or more turns, coils, or windings that laterally extend around a central opening (e.g., between positive and negative terminals of the coil that are coupled to a radio-frequency transmission line path in device 10). Coil 30 may convey NFC signals 44 (FIG. 1) through rear housing wall 12R. For example, when an external device is placed on or adjacent to rear housing wall 12R of device 10, coil 30 may overlap a coil on the external device and the two coils may convey NFC signals 44 through rear housing wall 12R. In the example of FIG. 2, coil 30 and its corresponding central opening lie within a plane parallel to the lateral area of rear housing wall 12R (e.g., the X-Y plane of FIG. 2). This is illustrative and non-limiting. If desired, coil 30 may be disposed in device 10 at other orientations (e.g., with the opening of coil 30 oriented orthogonal to the X-Y plane, around a ferrite core, etc.).

Magnet(s) 38 may be disposed at one or more locations around the lateral periphery of coil 30. Magnet(s) 38 may be disposed at predetermined locations that cause magnet(s) 38 to hold an external device against rear housing wall 12R at a predetermined position and/or orientation. For example, magnet(s) 38 may help to secure, fix, or lock the external device at a position and orientation in which coil 30 is aligned with and overlapping a corresponding coil on the external device (e.g., to increase or maximize near-field coupling between the coils through rear housing wall 12R). This may help to increases the wireless performance of coil 30 without requiring a user to manually and precisely place the other device in a particular orientation or position on device 10.

Antenna(s) 40 may include one or more antennas 40 that overlap the opening of coil 30, that are disposed at or around the lateral periphery of coil 30 (e.g., between two or more magnets 38), and/or that are laterally offset from coil 30 (e.g., that are disposed at other locations along the lateral area of rear housing wall 12R). Antenna(s) 40 may convey radio-frequency signals (e.g., radio-frequency signals 48, 50, and/or 42 of FIG. 1) through rear housing wall 12R.

It may be desirable for devices 10A and 10B (FIG. 1) to convey data between each other at relatively high data rates. Wired connections such as USB links between the devices can support high data rates but require bulky and cumbersome cabling coupled between USB ports on each device. To eliminate the need for wired connections, devices 10A and 10B may use radio-frequency signals 42 to perform high data rate wireless data transfer (e.g., using a wireless data transfer protocol that supports peak data rates similar to or higher than that of USB). In practice, increasing the frequency of radio-frequency signals 42 also increases the maximum data rate supported by the radio-frequency signals. For example, transmitting radio-frequency signals 42 at frequencies of 60 GHz or higher may allow the radio-frequency signals to convey wireless data at data rates similar to that of wired USB links. At the same time, increasing the frequency of radio-frequency signals 42 also increases the amount of attenuation and loss introduced to the signals while propagating between devices 10A and 10B. To help mitigate this attenuation, devices 10A and 10B may perform wireless data transfer using wireless signals 42 while the antenna(s) 40A on device 10A are placed in close proximity to the antenna(s) 40B on device 10B (e.g., when device 10A is placed onto or in contact with device 10B, such that antennas 40A and 40B form a wireless data connector between devices 10A and 10B).

In practice, the wireless data transfer performance of antennas 40A and 40B may be particularly susceptible to misalignment between the antennas when devices 10A and 10B are in close proximity to each other. Magnets 38 (FIG. 2), which may help to hold devices 10A and 10B together in a manner that aligns coil(s) 30A with coil(s) 30B for increasing NFC performance, may also help to hold devices 10A and 10B together in a manner that aligns antenna(s) 40A with antenna(s) 40B. However, magnets 38 may hold devices 10A and 10B together with a non-zero tolerance in position and orientation. This non-zero tolerance can cause antenna(s) 40A to become misaligned with respect to antenna(s) 40B. If care is not taken, misalignment between antennas 40A and 40B can reduce wireless data transfer performance between devices 10A and 10B (e.g., limiting data rate, introducing excessive data errors, etc.).

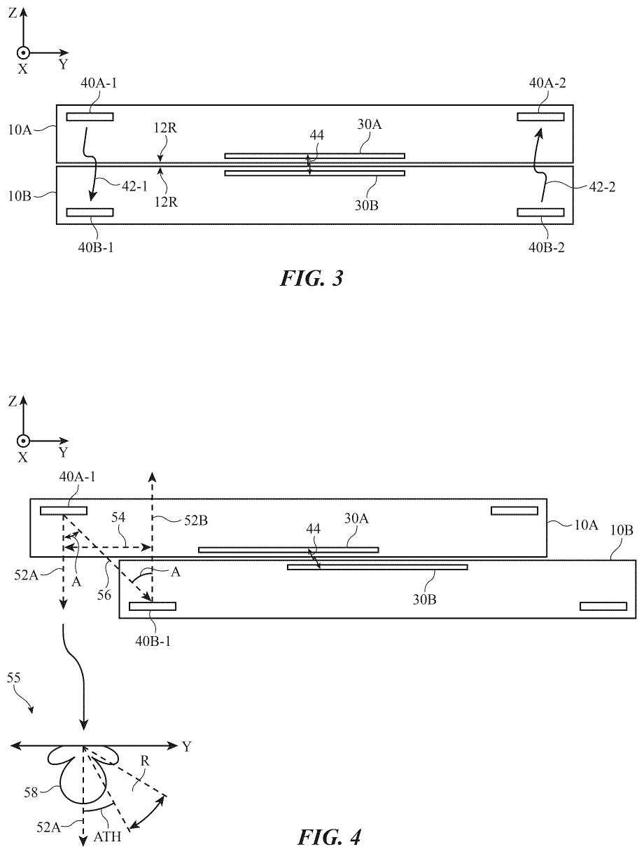

FIG. 3 is a cross-sectional side view showing how device 10A may be mounted to device 10B with the antennas 40A on device 10A in alignment with the antennas 40B on device 10B. Magnets 38A and 38B (FIG. 1) have been omitted from FIG. 3 for the sake of simplicity. As shown in FIG. 3, device 10A may be placed on or mounted to the rear housing wall 12R of device 10B (e.g., with the rear housing wall 12R of device 10A overlapping and/or placed into contact with the rear housing wall 12R of device 10B). Magnets 38 (FIG. 2) on one or both devices may help to hold device 10A to device 10B in this position/orientation (e.g., with coil(s) 30A on device 10A overlapping and aligned with coil(s) 30B on device 10B and/or with the antenna(s) 40A on device 10A overlapping and aligned with the antenna(s) 40B on device 10B). When coil(s) 30A are aligned with coil(s) 30B as shown in FIG. 3 (e.g., with coil(s) 30A completely overlapping coil(s) 30B), coils 30A and 30B may convey NFC signals 44 through the rear housing walls 12R of devices 10A and 10B with a maximum amount of near field coupling between the coils 30A and 30B.

In the example of FIG. 3, device 10A is illustrated as including at least a first antenna 40A-1 and a second antenna 40A-2 and device 10B is illustrated as including at least a first antenna 40B-1 and a second antenna 40B-2. In this example, antenna 40A-1 may transmit radio-frequency signals 42-1 to antenna 40B-1 through the rear housing walls 12R of devices 10A and 10B (e.g., antenna 40A-1 may be a transmit antenna for device 10A whereas antenna 40B-1 may be a receive antenna for device 10B). Antenna 40B-2 may concurrently transmit radio-frequency signals 42-2 to antenna 40A-2 through the rear housing walls 12R of devices 10A and 10B (e.g., antenna 40A-2 may be a receive antenna for device 10A whereas antenna 40B-2 is a transmit antenna for device 10B). This may, for example, allow devices 10A and 10B to perform bidirectional wireless data transfer at any given time.

This example is illustrative and non-limiting. If desired, both antennas 40A may transmit radio-frequency signals 42 while both antennas 40B concurrently receive radio-frequency signals 42 (e.g., increasing the rate of data transfer from device 10A to device 10B) or both antennas 40B may transmit radio-frequency signals 42 while both antennas 40A concurrently receive radio-frequency signals 42 (e.g., increasing the rate of data transfer from device 10B to device 10A). If desired, antennas 40A and 40B may switch between data transmission and data reception over time (e.g., using a time division duplexing scheme). If desired, a given antenna 40A and a given antenna 40B may both transmit and receive radio-frequency signals 42 at the same time (e.g., using a frequency division duplexing scheme, corresponding filtering, etc.). If desired, device 10A may include only a single antenna 40A and/or device 10B may include only a single antenna 40B used in wireless data transfer through rear housing walls 12R. If desired, device 10A may include more than two antennas 40A and/or device 10B may include more than two antennas 40B used in wireless data transfer through rear housing walls 12R. Antennas 40A-1 and 40A-2 may overlap any desired location along the lateral area of the rear housing wall 12R of device 10A (e.g., overlapping the central opening of coil(s) 30A, adjacent the lateral edge of coil(s) 30A, etc.). Similarly, antennas 40B-1 and 40B-2 may overlap any desired location along the lateral area of the rear housing wall 12R of device 10B (e.g., overlapping the central opening of coil(s) 30B, adjacent the lateral edge of coil(s) 30B, etc.).

In practice, device 10A may not be perfectly aligned with device 10B while overlapping device 10B. For example, the non-zero spatial (e.g., position/orientation) tolerance of the magnets 38 (FIG. 2) on devices 10A and 10B may cause antenna(s) 40A on device 10A to be misaligned or offset with respect to antenna(s) 40B on device 10B and/or may cause coil(s) 30A on device 10A to be misaligned or offset with respect to coil(s) 30B on device 10B. FIG. 4 is a cross-sectional side view showing one example of how device 10A may be misaligned with respect to device 10B while placed on device 10B.

As shown in FIG. 4, device 10A may be laterally offset from device 10B by a non-zero offset 54. Offset 54 of FIG. 4 may, for example, represent the maximum offset associated with the non-zero tolerance of magnets 38. Offset 54 may be, for example, less than or equal to 2 mm, 1.8 mm, 1.6 mm, 1.55 mm, 1.5 mm, or other values (e.g., depending on the tolerance of magnets 38). This offset causes coil(s) 30A to be partially non-overlapping with respect to coil(s) 30B (e.g., displaced by offset 54). This may reduce the near-field coupling between coils 30A and 30B and may reduce the efficiency of wireless power and/or data transfer between coils 30A and 30B. However, wireless power and data transfer using NFC signals 44 are more insensitive to misalignment than wireless data transfer using radio-frequency signals 42. As such, coils 30A and 30B may still convey NFC signals 44 with a satisfactory level of performance/efficiency despite offset 54.

Offset 54 also misaligns antenna(s) 40A with respect to antenna(s) 40B. For example, antenna 40A-1 may have a central axis 52A and antenna 40B-1 may have a central axis 52B that is laterally (radially) displaced, offset, or misaligned from central axis 52A of antenna 40A-1 by offset 54. Central axis 52A is oriented orthogonal/perpendicular to the plane or lateral area of antenna 40A-1 (e.g., in a boresight direction of antenna 40A-1) and extends through the lateral center of antenna 40A-1. Similarly, central axis 52B is oriented orthogonal/perpendicular to the plane or lateral area of antenna 40B-1 and extends through the lateral center of antenna 40B-1. In three-dimensional space, offset 54 causes antenna 40B-1 to be spatially separated from antenna 40A-1 by vector 56 (e.g., extending from the point where central axis 52A meets antenna 40A-1 to the point where central axis 52B meets antenna 40B-1 or vice versa). Vector 56 is oriented at an elevation angle A with respect to central axis 52A of antenna 40A-1 and is oriented at the same elevation angle A with respect to central axis 52B of antenna 40B-1. In the example of FIGS. 3 and 4, antennas 40A and 40B lie within planes parallel to the X-Y plane and central axes 52A and 52B extend parallel to the Z-axis.

Although coils 30A and 30B may still exhibit sufficient levels of wireless performance despite offset 54, if care is not taken, offset 54 may cause devices 10A and 10B to exhibit insufficient levels of performance in performing wireless data transfer between antennas 40A and 40B. This is because of the radiation patterns of antennas 40A and 40B can be more directional and thus more sensitive to misalignment than coils 30A and 30B, particularly given the relatively high frequency of radio-frequency signals 42.

Portion 55 of FIG. 4 plots one example of a radiation pattern that may be exhibited by antenna 40A-1 (e.g., when implemented as a single layer square patch antenna). Curve 58 plots the envelope of the radiation pattern of antenna 40A-1 as a function of elevation angle A relative to central axis 52A. As shown by curve 58, antenna 40A-1 may exhibit peak gain (e.g., realized gain) at boresight (e.g., in the direction of central axis 52A, at an elevation angle A=0 degrees). The gain (e.g., realized gain) of antenna 40A-1 sharply falls off as elevation angle A increases away from boresight. For example, at elevation angles A beyond a threshold elevation angle ATH (e.g., within angular region R), antenna 40A-1 may exhibit less than a threshold amount of gain that would otherwise be required for antenna 40A-1 to exhibit a sufficient level of wireless data transfer performance. Vector 56 lies within angular region R. As such, if care is not taken, antenna 40A-1 may exhibit an insufficient amount of gain for devices 10A and 10B to exhibit a sufficient level of wireless data transfer performance while antenna 40A-1 is misaligned from antenna 40B-1 by offset 54. To help mitigate the effects of offset 54 on wireless data transfer performance, antennas 40A and 40B may be provided with an increased size and/or may be disposed on substrates having a relatively low dielectric constant, antennas 40A and 40B may each include multiple symmetrically phased and/or oriented antenna elements, and/or antennas 40A and 40B may include antenna elements that are configured to exhibit boosted gain at elevation angles A within angular region R, as examples.

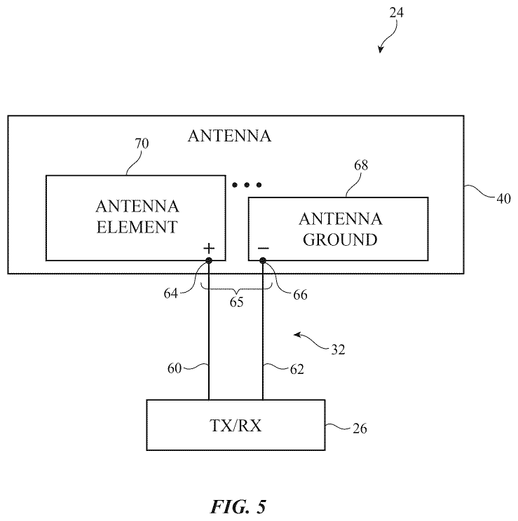

FIG. 5 is a schematic diagram showing how a given antenna 40 on device 10 (e.g., an antenna 40A on device 10A or an antenna 40B on device 10B of FIGS. 1, 3, and 4) may be fed by a corresponding non-NFC transceiver 26. As shown in FIG. 5, antenna 40 may include one or more antenna resonating (radiating) elements such as antenna element 70. Antenna 40 may also include one or more grounded conductive structures that form antenna ground 68 (sometimes also referred to herein as ground plane 68). Each antenna element 70 may include one or more radiating arms, slots (e.g., slot antenna resonating elements), waveguides, loops (e.g., loop antenna resonating elements), monopole arms (e.g., monopole antenna resonating elements), dipole arms (e.g., dipole antenna resonating elements), dielectric resonators (e.g., dielectric resonator antenna elements or columns), conductive patches (e.g., patch antenna resonating elements), parasitic elements, indirect feed elements, and/or any other desired electromagnetic radiating or resonating structures that radiate radio-frequency signals and/or that receive incident radio-frequency signals (e.g., radio-frequency signals 42 of FIG. 1). Antenna element 70 is sometimes also referred to herein as antenna radiator 70, antenna resonator 70, antenna radiating element 70, antenna resonating element 70, or radiator 70. If desired, a portion of antenna ground 68 may form a part of one or more antenna elements 70 (e.g., a ground-referenced dipole arm, one or more edges of a slot antenna resonating element, etc.).

Antenna 40 may have a corresponding antenna feed 65. Antenna feed 65 may include one or more positive antenna feed terminals 64. Each positive antenna feed terminal 64 may be coupled to a corresponding antenna element 70. If desired, an antenna element 70 in antenna 40 may be coupled to a single positive antenna feed terminal. If desired, an antenna element 70 in antenna 40 may be coupled to two positive antenna feed terminals at different locations on the antenna element (e.g., for conveying signals of orthogonal linear polarizations, circular polarizations, elliptical polarizations, etc.). If desired, one or more antenna elements 70 may include one or more parasitic elements that are not directly connected to positive antenna feed terminals but that are indirectly excited by one or more other conductors that are coupled to respective positive antenna feed terminals. Antenna feed 65 may also include a ground antenna feed terminal 66 coupled to antenna ground 68. If desired, one or more conductive paths (not shown) may couple one or more antenna elements 70 to antenna ground 68. These conductive paths are sometimes also referred to as ground paths, short paths, or return paths for antenna element(s) 70.

Non-NFC transceiver (TX/RX) 26 (e.g., non-NFC transceiver 26A or non-NFC transceiver 26B of FIG. 1) may be coupled to antenna feed 65 by one or more radio-frequency transmission line paths 32 (e.g., radio-frequency transmission line paths 32A or 32B of FIG. 1). Radio-frequency transmission line path 32 may include a signal conductor such as signal conductor 60 (e.g., a positive signal conductor). Radio-frequency transmission line path 32 may also include a ground conductor such as ground conductor 62. Ground conductor 62 may be coupled to ground antenna feed terminal 66 of antenna feed 65. Each positive antenna feed terminal 64 of antenna feed 65 may be coupled to the signal conductor(s) 60 in one or more of the radio-frequency transmission line paths 32 coupled to non-NFC transceiver 26.

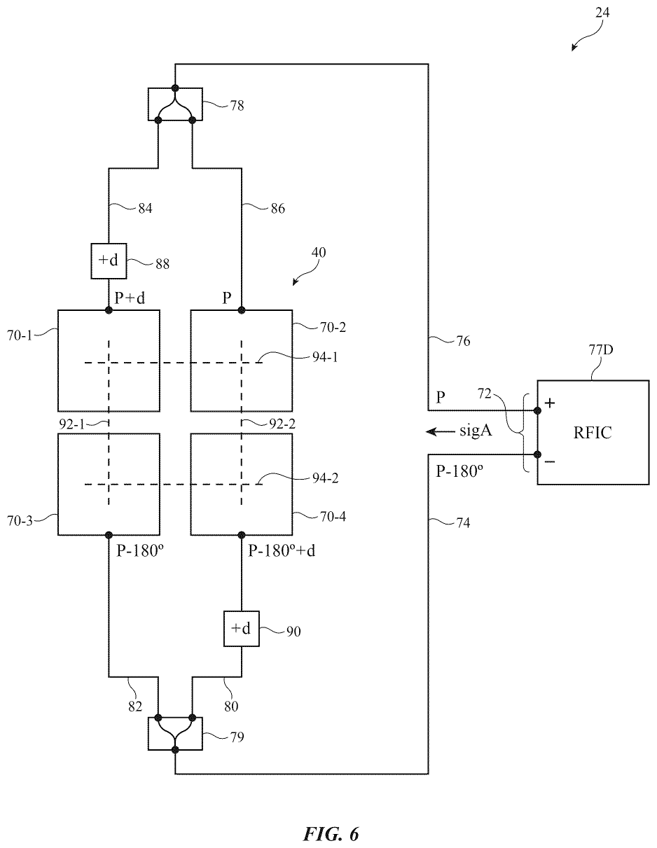

If desired, antenna 40 may be provided with multiple antenna elements 70 that are phased in a manner that mitigates the effects of offset 54 (FIG. 4) on wireless data transfer between devices 10A and 10B. FIG. 6 is a circuit diagram showing a first example in which antenna 40 includes four antenna elements 70 that are phased to mitigate the effects of offset 54 on wireless data transfer between devices 10A and 10B.

As shown in FIG. 6, wireless circuitry 24 on device 10 (e.g., wireless circuitry 24A on device 10A or wireless circuitry 24B on device 10B of FIG. 1) may include a radio-frequency integrated circuit (RFIC) 77D. RFIC 77D may include a non-NFC transceiver 26 that communicates using antenna 40. In the example of FIG. 6, RFIC 77D operates on differential radio-frequency signals. As such, RFIC 77D may include a differential signal port 72. During signal transmission, RFIC 77D may generate and output a differential radio-frequency signal such as differential signal sigA at differential signal port 72. Differential signal sigA may carry a stream of wireless data (e.g., according to a wireless data transfer protocol) at a carrier frequency in a corresponding frequency band (e.g., greater than 600 MHz, greater than 10 GHz, greater than 60 GHz, greater than 100 GHz, etc.).

Wireless circuitry 24 may include a differential pair of signal lines such as signal lines 76 and 74. Signal line 76 may be coupled to a first terminal of differential signal port 72. Signal line 74 may be coupled to a second terminal of differential signal port 72. Signal lines 76 and 74 may convey differential signal sigA to antenna 40 (e.g., differential signal sigA may include a differential signal pair carried by signal lines 76 and 74). Differential signal sigA may propagate through the first terminal of differential signal port 72 and along signal line 76 at a first phase P (e.g., zero degrees) and may propagate through the second terminal of differential signal port 72 and along signal line 74 at a second phase that differs from phase P by 180 degrees (e.g., signal line 74 may propagate differential signal sigA at a phase of P−180 degrees).

Antenna 40 may include a set of multiple antenna elements 70. Each antenna element 70 may be fed (e.g., at a respective positive antenna feed terminal 64 of FIG. 5) using a different phase of the same differential signal sigA and may radiate a corresponding radio-frequency signal (e.g., radio-frequency signal 42 of FIG. 1) for receipt by an external device. As shown in the example of FIG. 6, antenna 40 may include a set of four antenna elements 70 (e.g., antenna elements 70-1, 70-2, 70-3, and 70-4). This is illustrative and non-limiting. In general, antenna 40 may include any desired number of two or more antenna elements 70.

If desired, the antennas elements 70 in antenna 40 may be arranged in a symmetric pattern (e.g., on an underlying substrate). For example, antenna elements 70-1 and 70-2 may be aligned, arranged, or disposed along a first linear axis 94-1 (e.g., in a first row of a rectangular grid pattern of antenna elements 70 in antenna 40) and antenna elements 70-3 and 70-4 may be aligned, arranged, or disposed along a second linear axis 94-2 parallel to linear axis 94-1 (e.g., in a second row of the rectangular grid pattern of antenna elements 70 in antenna 40). Antenna elements 70-1 and 70-3 may be aligned, arranged, or disposed along a third linear axis 92-1 orthogonal to linear axes 94-1 and 94-2 (e.g., in a first column of the rectangular grid pattern of antenna elements 70 in antenna 40) and antenna elements 70-2 and 70-4 may be aligned, arranged, or disposed along a fourth linear axis 92-2 parallel to linear axis 92-1 (e.g., in a second column of the rectangular grid pattern of antenna elements 70 in antenna 40). This is illustrative and non-limiting and, in general, antenna elements 70 may be arranged in other symmetric patterns.

Differential signal sigA may be provided to each antenna element 70 in antenna 40 with a different respective phase in a manner that helps to compensate for offset 54 (FIG. 4) when communicating with a nearby or overlapping antenna in an external device. For example, differential signal sigA may be provided to antenna element 70-2 at phase P and antenna element 70-2 may radiate the signal with phase P, differential signal sigA may be provided to antenna element 70-1 at a different phase P+d and antenna element 70-1 may radiate the signal with phase P+d, differential signal sigA may be provided to antenna element 70-3 at a different phase P−180 degrees and antenna element 70-3 may radiate the signal with phase P−180 degrees, and differential signal sigA may be provided to antenna element 70-4 at a different phase P−180 degrees+d and antenna element 70-4 may radiate the signal with phase P−180 degrees+d.

As shown in FIG. 6, antenna 40 may be provided with a first signal splitter 78 having a first terminal coupled to signal line 76, a second terminal coupled to signal line 84, and a third terminal coupled to signal line 86. Signal line 84 may couple the second terminal of signal splitter 78 and thus signal line 76 to a positive antenna feed terminal on antenna element 70-1. Signal line 86 may couple the third terminal of signal splitter 78 and thus signal line 76 to a positive antenna feed terminal on antenna element 70-2. Signal splitter 78 may include a circuit node where signal lines 84 and 86 are coupled to signal line 76, a power divider, a signal coupler, two or more coupled lines, a transformer, and/or any other desired signal splitting components. Although signal splitter 78 is referred to herein as a signal splitter used in the transmission of differential signal sigA, signal splitter 78 may equivalently form a signal/power combiner during the reception of radio-frequency signals by antenna 40.

Antenna 40 may also be provided with a second signal splitter 79 having a first terminal coupled to signal line 74, a second terminal coupled to signal line 82, and a third terminal coupled to signal line 80. Signal line 82 may couple the second terminal of signal splitter 79 and thus signal line 74 to a positive antenna feed terminal on antenna element 70-3. Signal line 80 may couple the third terminal of signal splitter 79 and thus signal line 74 to a positive antenna feed terminal on antenna element 70-4. Signal splitter 79 may include a circuit node where signal lines 82 and 80 are coupled to signal line 74, a signal coupler, a power divider, two or more coupled lines, a transformer, and/or any other desired signal splitting components. Although signal splitter 79 is referred to herein as a signal splitter used in the transmission of differential signal sigA, signal splitter 79 may equivalently form a signal/power combiner during the reception of radio-frequency signals by antenna 40. Signal splitters 78 and 79 and signal lines 76, 74, 84, 86, 82, and 80 may collectively form the radio-frequency transmission line path 32 (FIG. 5) that feeds antenna 40 (e.g., RFIC 72D may be communicatively coupled to antenna element 70-1 via signal lines 76 and 84, may be communicatively coupled to antenna element 70-2 via signal lines 76 and 86, may be communicatively coupled to antenna element 70-3 via signal lines 74 and 82, and may be communicatively coupled to antenna element 70-4 via signal lines 74 and 80).

During signal transmission, signal splitter 78 passes differential signal sigA from signal line 76 onto both signal lines 84 and 86 at phase P while signal splitter 79 concurrently passes differential signal sigA from signal line 74 onto both signal lines 82 and 80 at phase P−180 degrees. Signal line 86 may provide, propagate, transmit, or carry differential signal sigA to antenna element 70-2 (e.g., feeding antenna element 70-2) at phase P. Antenna 40 may include a phase shifter 88 disposed on signal line 84 between signal splitter 78 and antenna element 70-1. Phase shifter 88 may add a non-zero phase shift d to the differential signal sigA on signal line 84, providing the signal to antenna element 70-1 (e.g., feeding antenna element 70-1) at phase P+d.

At the same time, signal line 82 may provide, propagate, transmit, or carry differential signal sigA to antenna element 70-3 (e.g., feeding antenna element 70-3) at phase P−180 degrees. Antenna 40 may include an additional phase shifter 90 disposed on signal line 80 between signal splitter 79 and antenna element 70-4. Phase shifter 90 may add the phase shift d to the differential signal sigA on signal line 80 (e.g., the same non-zero phase shift as applied by phase shifter 88), providing the signal to antenna element 70-4 (e.g., feeding antenna element 70-4) at phase P−180 degrees+d. Phase shifters 88 and 90 may be implemented using segments, stubs, or extensions of radio-frequency transmission line in signal lines 84 and 80, respectively, and/or may be implemented using electrical/discrete phase shifter components. If desired, phase shifters 88 and 90 may be fixed (non-adjustable) phase shifters that apply the same phase shift d to the transmitted signal over time (e.g., reducing manufacturing cost, signal loss, control routing complexity, etc.). Unlike signal paths 84 and 80, which include phase shifters, signal paths 86 and 82 may be free from phase shifters if desired (e.g., there may be no phase shifters disposed on signal lines 86 and 82).

The use of multiple symmetrically arranged antenna elements 70 in antenna 40 may serve to increase the effective electrical/radiating area of antenna 40 (relative to implementations where antenna 40 includes only a single antenna element 70) in a manner that helps to mitigate the effect of offset 54 (FIG. 4) on wireless data transfer with an external device. Phase shift d may be selected to further increase the effective area of antenna 40 to further widen the radiation pattern of antenna 40 to mitigate the effect of offset 54 on wireless data transfer. Phase shift d may, for example, be approximately equal to +/−90 degrees (e.g., phase shift d may have a magnitude or absolute value of 80-100 degrees, 85-95 degrees, 88-92 degrees, 89-91 degrees, 89.5-90.5 degrees, or 90 degrees). Splitting the transmitted signal between multiple symmetrically arranged antenna elements 70 and phasing the transmission of the signal across each of the antenna elements 70 in this way may, for example, help the antenna to achieve an axisymmetric radiation pattern, increase the effective area of antenna 40, and/or effectively widen the radiation pattern of antenna 40. This may, for example, also help antenna 40 to achieve greater than a threshold amount of gain in the angular direction towards an external antenna offset from antenna 40 by offset 54 (FIG. 4).

The example of FIG. 6 illustrates signal transmission by antenna 40 for the sake of clarity. Antenna 40 may equivalently receive radio-frequency signals and may pass the radio-frequency signals as a differential signal to RFIC 77D (e.g., RFIC 77D may receive differential signal sigA using antenna 40). If desired, antenna elements 70 may be linearly polarized (e.g., may convey radio-frequency signals with a single linear polarization). If desired, each antenna element 70 may include two positive antenna feed terminals that are each fed as shown in FIG. 6 (e.g., where RFIC 77D has first and second differential feed ports each coupled to a respective positive antenna feed terminal on each antenna element 70 over corresponding signal paths and where the antenna elements are phased in the same manner for both of its positive antenna feed terminals). In these implementations, each antenna element 70 may be a dual-polarization antenna element that conveys radio-frequency signals with two orthogonal linear polarizations and/or each antenna element 70 may be a circularly polarized antenna element that conveys radio-frequency signals with a circular polarization (e.g., by adjusting the phase relationship between the two positive antenna feed terminals of each antenna element 70 over time). The phase shifts d imparted by phase shifters 88 and 90 may be selected to maintain the illustrated phase relationship between antenna elements 70 while also maintaining the circular polarization of antenna elements 70-1 and 70-4. Conveying circularly polarized radio-frequency signals may, for example, help to make antenna 40 even more insensitive to misalignment or offsets between antenna 40 and the corresponding antenna on the overlapping external device.

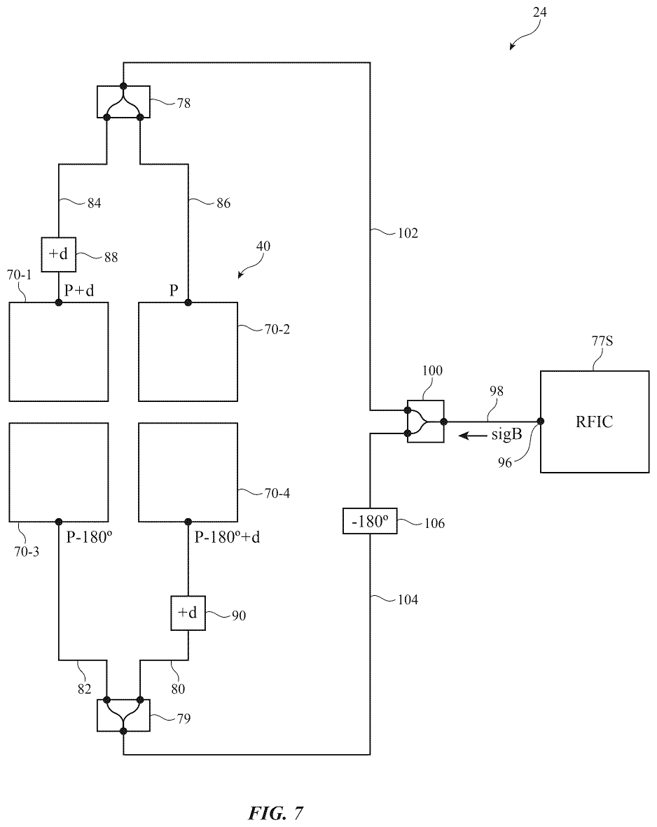

The example of FIG. 6 in which differential signal sigA is transmitted to antenna 40 is illustrative and non-limiting. FIG. 7 is a circuit diagram showing another example in which a single-ended signal sigB is transmitted to antenna 40. As shown in FIG. 7, wireless circuitry 24 may include an RFIC 77S that operates on single-ended signals. RFIC 77S may include a non-NFC transceiver 26 that communicates using antenna 40. RFIC 77S may include a single-ended signal port 96. During signal transmission, RFIC 77S may generate and output a single-ended radio-frequency signal such as single-ended signal sigB at single-ended signal port 96. Single-ended signal sigB may carry a stream of wireless data (e.g., according to a wireless data transfer protocol) at a carrier frequency in a corresponding frequency band (e.g., greater than 600 MHz, greater than 10 GHz, greater than 60 GHz, greater than 100 GHz, etc.).

To distribute single-ended signal sigB to each of the antenna elements 70 of antenna 40, wireless circuitry 24 may include a third signal splitter such as signal splitter 100. Signal splitter 100 may have a first terminal coupled to signal line 98, a second terminal coupled to signal line 102, and a third terminal coupled to signal line 104. Signal line 102 may couple the second terminal of signal splitter 100 to the first terminal of signal splitter 78. Signal line 104 may couple the third terminal of signal splitter 100 to the first terminal of signal splitter 79. Signal splitter 100 may include a circuit node where signal lines 102 and 104 are coupled to signal line 98, a power divider, a signal coupler, two or more coupled lines, a transformer, and/or any other desired signal splitting components. Although signal splitter 100 is referred to herein as a signal splitter used in the transmission of single-ended signal sigB, signal splitter 78 may equivalently form a signal/power combiner during the reception of radio-frequency signals by antenna 40.

To maintain the same phase relationship between antenna elements 70 as in implementations where the RFIC outputs a differential signal (FIG. 6), wireless circuitry 24 may include a phase shifter 106 disposed on signal line 104 between signal splitter 100 and signal splitter 79. Phase shifter 106 may apply a 180 degree phase shift to signals carried along signal line 104. Alternatively, phase shifter 106 may be disposed on signal line 102. Alternatively, a first phase shifter may be disposed on signal line 102 and a second phase shifter may be disposed on signal line 104, where the phase shifters apply respective phase shifts to single-ended signal sigB such that the signals are provided to signal splitters 79 and 78 at phases that are 180 degrees apart.

During signal transmission, RFIC 77S may output single-ended signal sigB at phase P onto signal line 98 over single-ended signal port 96. Signal splitter 100 may split single-ended signal sigB at phase P onto signal lines 102 and 104. Phase shifter 106 may phase shift the single-ended signal sigB on signal line 104 by 180 degrees. This may cause signal splitter 79 to receive single-ended signal sigB at a phase of P−180 degrees. In this way, although RFIC 77S outputs signal sigB as a single-ended signal, the signal is still provided to signal splitters 78 and 79 as a differential signal pair (e.g., where the signal at signal splitter 78 is 180 degrees out of phase with respect to the signal at signal splitter 79). In this way, the signal may be provided to antenna elements 70 with the same phase relationship as in FIG. 6.

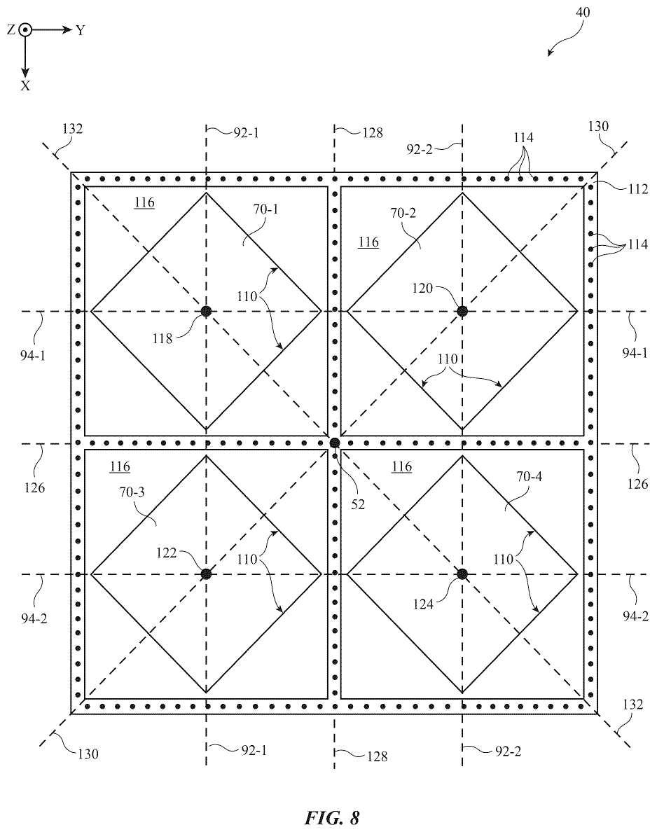

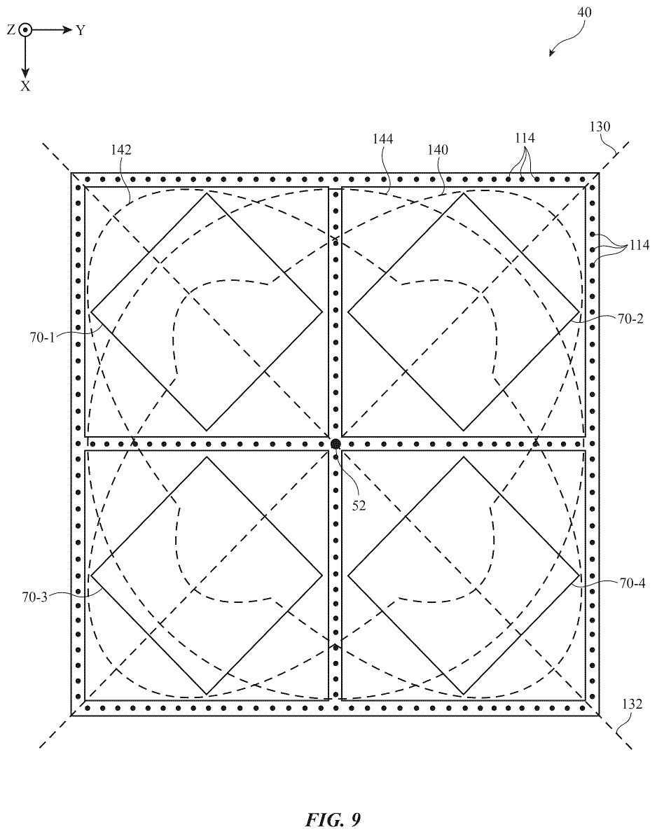

FIG. 8 is a top view showing one example of how antenna elements 70-1, 70-2, 70-3, and 70-4 may be symmetrically arranged on an underlying substrate 116 in a manner that helps to mitigate the effect of offset 54 (FIG. 4) on wireless data transfer. In the example of FIG. 8, antenna elements 70-1, 70-2, 70-3, and 70-4 are arranged in an axisymmetric pattern/orientation about four linear axes 132, 130, 126, and 128 parallel to the X-Y plane and oriented at different angles about the central axis 52 of antenna 40 (e.g., antenna elements 70 may be arranged in a four-fold symmetric pattern such that antenna 40 is axisymmetric about four different co-planar linear axes). Linear axes 132, 130, 126, and 128 may intersect each other at central axis 52 of antenna 40. Linear axis 126 may be orthogonal to linear axis 128. Linear axis 130 may be orthogonal to linear axis 132. Linear axis 130 may be oriented at a 45 degree angle with respect to linear axes 128 and 126 about central axis 52. Linear axis 132 may also be oriented at a 45 degree angle with respect to linear axes 128 and 126 about central axis 52.

As shown in FIG. 8, antenna 40 may include a grounded ring 112 of conductive traces on substrate 116. Antenna 40 may include fences of conductive vias 114 that extend from grounded ring 112 downwards through substrate 116 to an underlying layer of grounded conductive traces, sometimes also referred to herein as a ground layer of antenna 40. Conductive vias 114 may hold grounded ring 112 at a ground potential. Grounded ring 112 may laterally surround each antenna element 70 in antenna 40, forming a different respective cavity within which each antenna element 70 is disposed. Each cavity may be laterally surrounded by four fences of conductive vias 114. Grounded ring 112 and conductive vias 114 may, for example, help to increase isolation between antenna elements 70 and between antenna 40 and other electronic components in device 10.

Antenna element 70-1 has a central axis 118 that extends through the lateral center of antenna element 70-1 and parallel to the central axis 52 of antenna 40. Antenna element 70-2 has a central axis 120 that extends through the lateral center of antenna element 70-2 and parallel to the central axis 118 of antenna element 70-1. Antenna element 70-3 has a central axis 122 that extends through the lateral center of antenna element 70-3 and parallel to the central axis 118 of antenna element 70-1. Antenna element 70-4 has a central axis 124 that extends through the lateral center of antenna element 70-4 and parallel to the central axis 118 of antenna element 70-1.

The central axes 118 and 120 of antenna elements 70-1 and 70-2 may be disposed along linear axis 94-1 (e.g., in a first row of antenna elements in antenna 40). The central axes 122 and 124 of antenna elements 70-3 and 70-4 may be disposed along linear axis 94-2 (e.g., in a second row of antenna elements in antenna 40). The central axes 118 and 122 of antenna elements 70-1 and 70-3 may be disposed along linear axis 92-1 (e.g., in a first column of antenna elements in antenna 40). The central axes 120 and 124 of antenna elements 70-2 and 70-4 may be disposed along linear axis 92-2 (e.g., in a second column of antenna elements in antenna 40). This placement may cause antenna 40 to exhibit spatial, lateral, and/or rotational symmetry about a set of different axes and may help antenna 40 to exhibit an axisymmetric radiation pattern.

Linear axis 132 may extend through central axis 118 of antenna element 70-1, central axis 52 of antenna 40, and central axis 124 of antenna element 70-4. Put differently, linear axes 94-1, 132, and 92-1 may all intersect at central axis 118 of antenna element 70-1 and linear axes 94-2, 92-2, and 132 may all intersect at central axis 124 of antenna element 70-4 (e.g., antenna element 70-1 may be aligned with or centered about all three of linear axes 94-1, 92-1, and 132 and antenna element 70-4 may be aligned with or centered about all three of linear axes 94-2, 92-2, and 132).

Linear axis 130 may extend through central axis 120 of antenna element 70-2, central axis 52 of antenna 40, and central axis 122 of antenna element 70-3. Put differently, linear axes 94-1, 130, and 92-2 may all intersect at central axis 120 of antenna element 70-2 and linear axes 94-2, 92-1, and 130 may all intersect at central axis 122 of antenna element 70-3 (e.g., antenna element 70-3 may be aligned with all three of linear axes 94-2, 92-1, and 130 and antenna element 70-2 may be aligned with all three of linear axes 94-1, 92-2, and 130).

Antenna elements 70-1, 70-2, 70-3, and 70-4 may also be rotated at a non-zero angle (e.g., a 45 degree angle) with respect to the rows (e.g., linear axes 94) and the columns (e.g., linear axes 92) of antenna 40. For example, as shown in FIG. 8, each antenna element 70 may have a set of lateral edges 110 (e.g., four lateral edges in implementations where antenna elements are square or rectangular). The lateral edges 110 of each antenna element 70 may be rotated at the same non-zero angle (e.g., 45 degrees) relative to linear axes 94-1, 94-2, 92-1, and 92-2. Each antenna element 70 may, for example, have first and second opposing lateral edges that extend parallel to linear axis 132 and may have third and fourth opposing lateral edges that extend parallel to linear axis 130. This may also configure the lateral edges 110 of each antenna element 70 to be oriented at 45 degree angles with respect to the fences of conductive vias 114 and the segments of grounded ring 112 surrounding that antenna element. This may, for example, cause antenna 40 to exhibit an axisymmetric radiation pattern that helps to mitigate the effects of offset 54 (FIG. 4) on the wireless data transfer performance of antenna 40 (e.g., in addition to or instead of the phasing between antenna elements 70 as shown in FIGS. 6 and 7).

FIG. 9 illustrates different radiation patterns of antenna 40 under different feeding conditions (e.g., under different combinations of active antenna elements 70). Antenna 40 may, for example, be switched between at least first, second, and third operating modes or states. In the first operating mode, antenna elements 70-3 and 70-2 are concurrently active (e.g., convey radio-frequency signals) while antenna elements 70-1 and 70-4 are inactive (e.g., do not convey radio-frequency signals). In the second operating mode, antenna elements 70-1 and 70-4 are concurrently active while antenna elements 70-2 and 70-3 are inactive. In the third operating mode, antenna elements 70-1, 70-2, 70-3, and 70-4 are all active.

As shown in FIG. 9, antenna 40 may exhibit radiation pattern 142 (illustrated as a two-dimensional projection onto the X-Y plane) while in the first operating mode. Antenna 40 may exhibit radiation pattern 140 while in the second operating mode. Antenna 40 may exhibit radiation pattern 144 while in the third operating mode.

As shown by radiation pattern 142, activating antenna elements 70-2 and 70-3 may effectively widen the radiation pattern of antenna 40 at elevation angles along linear axis 132. This may, for example, serve to boost the gain of antenna 40 at angles that mitigate offsets, displacements, or misalignments along linear axis 132 between antenna 40 and the antenna on an overlapping device. Similarly, as shown by radiation pattern 140, activating antenna elements 70-1 and 70-4 may effectively widen the radiation pattern of antenna 40 at elevation angles along linear axis 130. This may, for example, serve to boost the gain of antenna 40 at angles that mitigate offsets, displacements, or misalignments along linear axis 130 between antenna 40 and the antenna on an overlapping device.

As shown by radiation pattern 144, activating all of the antenna elements 70 in antenna 40 may effectively widen the radiation pattern of antenna 40 at elevation angles along both linear axis 132 and linear axis 130. This may, for example, serve to boost the gain of antenna 40 at all angles about central axis 52, helping to mitigate offsets, displacements, or misalignments along all radial directions extending away from central axis 52. Radiation pattern 144 is four-fold axisymmetric about linear axis 130, linear axis 132, linear axis 126 (FIG. 8), and linear axis 128 (FIG. 8).

If desired, device 10 may selectively activate different antenna elements 70 in antenna 40 based on the offset direction between antenna 40 and an overlapping antenna (e.g., by switching different combinations of antenna elements 70 into or out of use). For example, device 10 may activate antenna elements 70-2 and 70-3 when communicating with an external antenna that is radially offset along linear axis 132 relative to central axis 52, may activate antenna elements 70-1 and 70-4 when communicating with an external antenna that is radially offset along linear axis 130 relative to central axis 52, and/or may activate antenna elements 70-1, 70-2, 70-3, and 70-4 when communicating with an external antenna that is offset along other radial directions from central axis 52. If desired, antenna elements 70-1 and 70-4 may be omitted from antenna 40 (e.g., in implementations where an overlapping antenna is more likely to be offset along linear axis 132 than in other directions) or antenna elements 70-2 and 70-3 may be omitted from antenna 40 (e.g., in implementations where an overlapping antenna is more likely to be offset along linear axis 130 than in other directions).

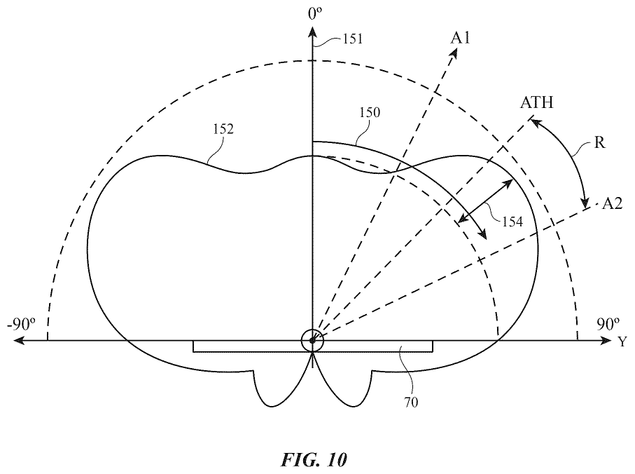

To help further mitigate the effect of offset 54 (FIG. 4) on wireless data transfer, if desired, one or more of the antenna elements 70 in antenna 40 may be implemented using antenna structures that configure antenna 40 to exhibit a tilted radiation pattern with boosted gain at elevation angles away from boresight (e.g., at elevation angles oriented towards an external antenna that is offset from antenna 40 by offset 54). FIG. 10 is a cross-sectional side view showing how antenna 40 may exhibit a radiation pattern with boosted gain at elevation angles oriented towards an offset external antenna.

As shown in FIG. 10, the antenna element(s) 70 in antenna 40 may configure antenna 40 to exhibit a radiation pattern 152 (e.g., illustrated in projection onto the Y-Z plane of FIGS. 2-4, 8, and 9). The boresight direction (angle) of antenna element 70 is at an elevation angle A=0 degrees, in the direction of the central axis 151 of antenna element 70 (e.g., central axis 118 when antenna element 70 forms antenna element 70-1 of FIG. 8, central axis 120 when antenna element 70 forms antenna element 70-2 of FIG. 8, central axis 122 when antenna element 70 forms antenna element 70-3 of FIG. 8, or central axis 124 when antenna element 70 forms antenna element 70-4 of FIG. 8).

Offset 54 (FIG. 4) may cause the external antenna to be located at an elevation angle A within angular region R relative to the point where central axis 151 meets the lateral area of antenna 40. Angular region R may include elevation angles greater than threshold elevation angle ATH and less than elevation angle A2. Threshold elevation angle ATH may be, for example, 30 degrees, 40 degrees, 45 degrees, 50 degrees, 60 degrees, 10-20 degrees, 10-30 degrees, 10-60 degrees, 30-60 degrees, greater than 10 degrees, greater than 20 degrees, greater than 30 degrees, less than 60 degrees, or another elevation angle. Elevation angle A2 may be, for example, 60 degrees, 70 degrees, 75 degrees, 80 degrees, or another elevation angle greater than threshold elevation angle ATH.

The structures in antenna element 70 may configure antenna element 70 to exhibit boosted gain at elevation angles within angular region R. For example, the gain (e.g., realized gain) of antenna element 70 at elevation angles A within angular region R may exceed, by as much as margin 154 (e.g., 0.5-10 dB, greater than 0.5 dB, greater than 1 dB, etc.), the gain (e.g., realized gain) of antenna 40 at an elevation angle A1 that is between threshold elevation angle ATH and boresight. Angle A1 may be 30 degrees, 40 degrees, 35 degrees, 25 degrees, 20 degrees, or another angle between 0 degrees and 30 degrees. If desired, the gain of antenna element 70 at elevation angles within angular region R may exceed the gain of antenna element 70 at boresight and/or may exceed the gain of antenna element 70 across all elevation angles between boresight and elevation angle A1. In this way, the radiation pattern 152 and/or the peak gain (e.g., realized gain) of antenna element 70 may be tilted away from boresight, as shown by arrow 150, to overlap angular region R. This may help to increase wireless data transfer performance by antenna 40 while communicating with an external antenna that is misaligned from antenna 40 by offset 54 of FIG. 4. The example of FIG. 10 is illustrative and non-limiting. In practice, radiation pattern 152 may have other shapes.

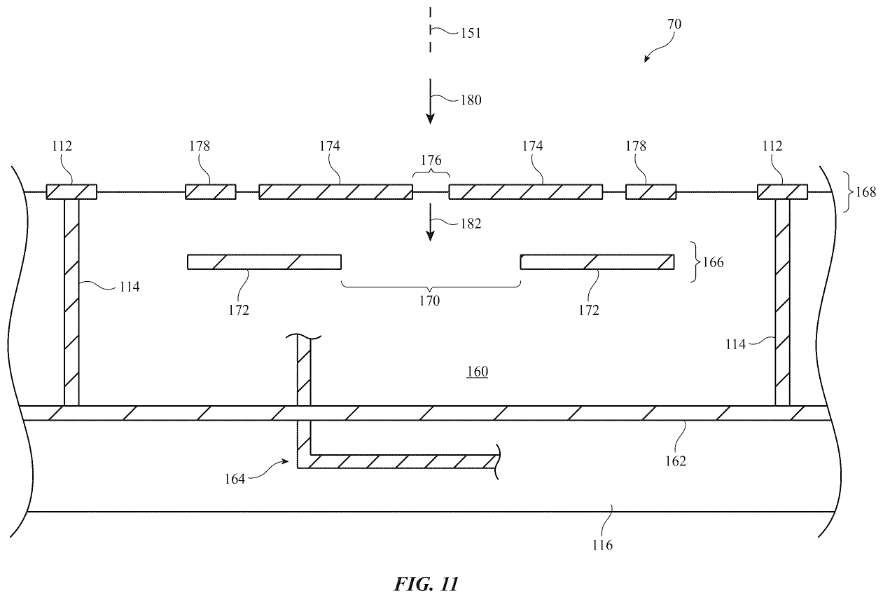

In general, the antenna element(s) 70 in antenna 40 may include any desired antenna structures that configure antenna 40 to exhibit radiation pattern 152. FIG. 11 is a cross-sectional side view showing one illustrative example in which antenna element 70 includes stacked patch antenna structures.

As shown in FIG. 11, antenna element 70 may be integrated into substrate 116. Substrate 116 may include a stack of interleaved insulator (e.g., dielectric or semiconductor) layers and metallization (e.g., conductive) layers. Substrate 116 may, as examples, include a rigid or flexible printed circuit board, a stacked ceramic substrate, or a plastic substrate. Substrate 116 may include at least a grounded metallization layer that forms ground layer 162, a first metallization layer 166 overlapping ground layer 162, and a second metallization layer 168 overlapping metallization layer 166 and ground layer 162 (e.g., metallization layer 166 may be interposed between metallization layer 168 and ground layer 162). Metallization layer 168 may form the uppermost (top) layer of substrate 116 or may, if desired, be embedded within substrate 116. The dielectric constant of the dielectric layer(s) in substrate 116 may be selected to be relatively low (e.g., less than 4) to increase the effective electromagnetic area of the antenna in a manner that helps to mitigate the effect of offset 54 on wireless data transfer.

Metallization layer 168 may include grounded ring 112 laterally extending around antenna element 70. Fences of conductive vias 114 may extend through substrate 116 to short grounded ring 112 to ground layer 162. Conductive vias 114, grounded ring 112, and ground layer 162 may surround a cavity 160 in substrate 116. Antenna element 70 may be disposed within cavity 160 and may convey radio-frequency signals through an open end of cavity 160.

Antenna element 70 may include a first set of conductive patches 172 in metallization layer 166. Conductive patches 172 may be laterally separated from each other by a central opening 170. Antenna element 70 may also include a conductive patch 174 and a second set of conductive patches 178 in metallization layer 168. Conductive patches 178 may laterally surround conductive patch 174 and may be laterally separated from conductive patch 174. If desired, a slot 176 may be disposed within conductive patch 174 (e.g., overlapping the central axis 151 of antenna element 70). Conductive patch 174 may overlap central opening 170 in metallization layer 166 and may, if desired, at least partially overlap conductive patches 172 in metallization layer 166. Conductive patches 178 may at least partially overlap conductive patches 172 or may, if desired, be non-overlapping with respect to conductive patches 172.

Antenna element 70 may be fed using one or more signal conductors 164. Signal conductor 164 may include one or more conductive traces in substrate 116 (e.g., where ground plane 162 is interposed between the conductive traces and antenna element 70) and one or more conductive vias that extend from the conductive traces, through substrate 116, to a conductive patch 172 and/or to conductive patch 174 (e.g., at a positive antenna feed terminal of antenna element 70). In this way, conductive patch 174 and/or a conductive patch 172 may form a directly fed patch antenna resonating element whereas the remaining conductive patches in antenna element 70 form parasitic (e.g., indirectly fed) patch antenna resonating elements. If desired, antenna element 70 may include multiple positive antenna feed terminals coupled to different signal conductors 164 for covering multiple orthogonal linear polarizations and/or a circular polarization.

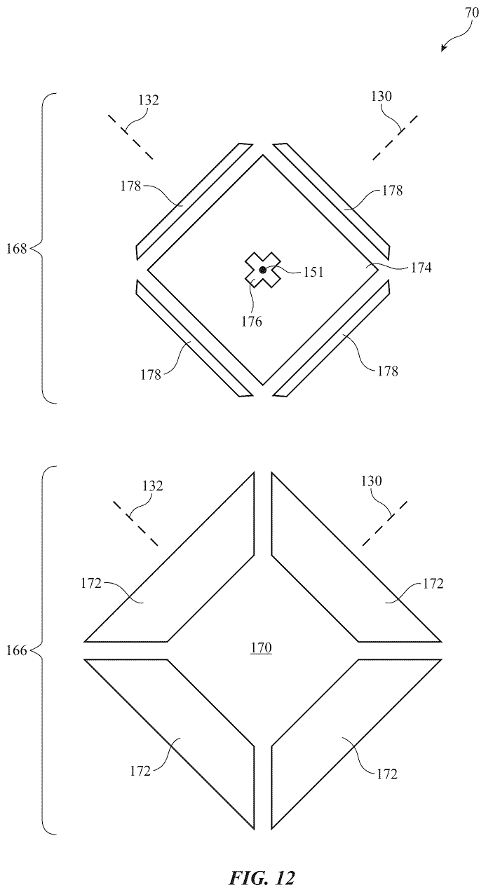

FIG. 12 is an exploded top view showing the conductive patches 174, 178, and 172 in antenna element 70. As shown in FIG. 12, metallization layer 166 (e.g., as viewed in the direction of arrow 182 of FIG. 11) may include a set of four conductive patches 172 that laterally surround central opening 170. Conductive patches 172 may, for example, each have a trapezoidal shape with first and second edges of different lengths oriented orthogonal to one of linear axis 132 or linear axis 130 and with third and fourth edges of the same length that couple opposing sides of the first edge to opposing sides of the second edge. Each conductive patch 172 may be laterally separated from an opposing conductive patch 172 by central opening 170 and may be laterally separated from the other two conductive patches 172 by respective dielectric slots that are free of conducive material.

As shown in FIG. 12, metallization layer 168 (e.g., as viewed in the direction of arrow 180 of FIG. 11) may include conductive patch 174 and four conductive patches 178. Conductive patch 174 may, for example, be a square patch having two lateral edges (e.g., lateral edges 110 of FIG. 8) parallel to linear axis 132 and two lateral edges parallel to linear axis 130. Conductive patch 174 may be laterally interposed between first and second conductive patches 178. Conductive patch 174 may be laterally interposed between third and fourth conductive patches 178. Conductive patches 178 may, for example, be trapezoidal patches each extending along (e.g., parallel to) a respective lateral edge of conductive patch 174. Conductive patches 178 may be thinner than conductive patches 172 if desired.

Slot 176 may be disposed in conductive patch 174 (e.g., slot 176 may be a closed slot that is completely surrounded by the conductive material of patch 174). Slot 176 may overlap central axis 151 of antenna element 70. Slot 176 may be, for example, a cross or X-shaped slot having first and second arms extending parallel to linear axis 132 and having third and fourth arms extending parallel to linear axis 130. If desired, slot 176 may form a radiating slot that contributes to the frequency response and/or radiation pattern of antenna element 70.

Conductive patches 174, 178, and 172 and optionally slot 176 may collectively contribute to the radiation pattern of antenna element 70 and may cause antenna element 70 to exhibit a tilted radiation pattern such as radiation pattern 152 (FIG. 10) having boosted gain within angular region R. This may help to mitigate the effect of offset 54 (FIG. 5) on wireless data transfer by antenna 40 (e.g., in addition to or instead of the other techniques described above). The example of FIGS. 11 and 12 is illustrative and non-limiting. If desired, antenna element 70 may include only a single layer of one or more conductive patches, may include more than two layers of conductive patches, the conductive patches in antenna element 70 may have any desired shape (e.g., any desired number of straight and/or curved edges), the conductive patches in antenna element 70 may be in other orientations, and/or the conductive patches in antenna element 70 may be replaced with other types of antenna resonating elements (e.g., monopole antenna elements, inverted-F antennas elements, planar inverted-F antenna elements, loop antenna elements, slot antenna elements, etc.) that configure antenna element 70 to exhibit a desired radiation pattern for helping to mitigate the effects of offset 54 (e.g., that configure antenna element 70 to exhibit radiation pattern 152 of FIG. 10).

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is merely illustrative and various modifications can be made to the described embodiments. The foregoing embodiments may be implemented individually or in any combination.

What is claimed is:

1. Wireless circuitry comprising:
a transceiver configured to convey a signal;
a first antenna element communicatively coupled to the transceiver; and
a second antenna element communicatively coupled to the transceiver, wherein
the first antenna element is configured to convey the signal at a first phase, and
the second antenna element is configured to convey the signal at a second phase that is 180 degrees less than the first phase concurrent with the first antenna element conveying the signal.

2. The wireless circuitry of claim 1, further comprising:
a third antenna element communicatively coupled to the transceiver, wherein the third antenna element is configured to convey the signal at a third phase concurrent with the first antenna element conveying the signal, the third phase being greater than the first phase by a phase shift.

3. The wireless circuitry of claim 2, further comprising:
a fourth antenna element communicatively coupled to the transceiver, wherein the fourth antenna element is configured to convey the signal at a fourth phase concurrent with the second antenna element conveying the signal, the fourth phase being greater than the second phase by the phase shift.

4. The wireless circuitry of claim 3, wherein the phase shift has a magnitude between 85 degrees and 95 degrees.

5. The wireless circuitry of claim 3, wherein the first and third antenna elements are aligned along a first linear axis and wherein the second and fourth antenna elements are aligned along a second linear axis parallel to the first linear axis.

6. The wireless circuitry of claim 5, wherein the third and second antenna elements are aligned along a third linear axis orthogonal to the first linear axis and wherein the first and fourth antenna elements are aligned along a fourth linear axis parallel to the third linear axis.

7. The wireless circuitry of claim 6, wherein the first, second, third, and fourth antenna elements each have respective first and second edges that extend parallel to a fifth linear axis and each have respective third and fourth edges that extend parallel to a sixth linear axis orthogonal to the fifth linear axis, the fifth linear axis being oriented at 45 degree angles with respect to the first, second, third, and fourth linear axes.

8. The wireless circuitry of claim 3, further comprising:
a first signal line coupled to the first antenna element;
a second signal line coupled to the second antenna element;
a third signal line coupled to the third antenna element;
a first phase shifter on the third signal line and configured to apply the phase shift to the signal;
a fourth signal line coupled to the fourth antenna element; and
a second phase shifter on the fourth signal line and configured to apply the phase shift to the signal.

9. The wireless circuitry of claim 8, further comprising:
a first signal splitter having a first terminal coupled to the first signal line and a second terminal coupled to the third signal line;
a fifth signal line that communicatively couples a third terminal of the first signal splitter to the transceiver;
a second signal splitter having a first terminal coupled to the second signal line and a second terminal coupled to the fourth signal line; and
a sixth signal line that communicatively couples a third terminal of the second signal splitter to the transceiver.

10. The wireless circuitry of claim 9, wherein the transceiver comprises a differential signal transceiver having a differential signal port, a first terminal of the differential signal port is coupled to the fifth signal line, a second terminal of the differential signal port is coupled to the sixth signal line, the signal has the first phase on the fifth signal line, and the signal has the second phase on the sixth signal line.

11. The wireless circuitry of claim 9, further comprising:
a third signal splitter having a first terminal coupled to the fifth signal line and a second terminal coupled to the sixth signal line;
a seventh signal line coupled to a third terminal of the third signal splitter, wherein the transceiver comprises a single-ended signal transceiver having a single-ended signal port coupled to the seventh signal line; and
a third phase shifter on the sixth signal line and configured to apply a 180 degree phase shift to the signal.

12. The wireless circuitry of claim 8, wherein there are no phase shifters on the first and second signal lines.

13. The wireless circuitry of claim 1, wherein the first antenna element is configured to exhibit a peak gain at an elevation angle greater than or equal to 30 degrees from a boresight of the first antenna element.

14. An antenna comprising:
a substrate;
fences of conductive vias extending through the substrate and laterally surrounding first, second, third, and fourth cavities; and
first, second, third, and fourth antenna elements on the substrate within the first, second, third, and fourth cavities, respectively, wherein
a first linear axis extends through central axes of the first and second antenna elements,
a second linear axis parallel to the first linear axis extends through central axes of the third and fourth antenna elements,
a third linear axis orthogonal to the first linear axis extends through the central axes of the first and third antenna elements,
a fourth linear axis parallel to the third linear axis extends through the central axes of the second and fourth antenna elements,
the first, second, third, and fourth antenna elements have respective first and second edges extending parallel to a fifth linear axis extending through the central axes of the first and fourth antenna elements, and
the first, second, third, and fourth antenna elements have respective third and fourth edges extending parallel to a sixth linear axis extending through the central axes of the second and third antenna elements.

15. The antenna of claim 14, wherein:
the first, second, third, and fourth antenna elements are configured to concurrently transmit a radio-frequency signal;
the second antenna element is configured to transmit the radio-frequency signal with a first phase;
the first antenna element is configured to transmit the radio-frequency signal with a second phase that is greater than the first phase by a phase shift;
the third antenna element is configured to transmit the radio-frequency signal with a third phase that is 180 degrees less than the first phase; and
the fourth antenna element is configured to transmit the radio-frequency signal with a fourth phase that is greater than the third phase by the phase shift.

16. The antenna of claim 14, wherein the first, second, third, and fourth antenna elements are configured to convey a circular polarized radio-frequency signal.

17. The antenna of claim 14, wherein the first antenna element comprises:
a first set of conductive patches in a first metallization layer of the substrate;
a conductive patch in a second metallization layer of the substrate, overlapping a central opening between the first set of conductive patches, and having a cross-shaped slot overlapping the central axis of the first antenna element; and
a second set of conductive patches in the second metallization layer and laterally surrounding the conductive patch.

18. The antenna of claim 14, wherein the antenna is configured to radiate at a frequency greater than or equal to 60 GHz, the fifth and sixth linear axes extend at 45 degree angles with respect to the first, second, third, and fourth linear axes, and the substrate has a dielectric constant less than or equal to 4.0.

19. An electronic device comprising:
a housing having a dielectric wall;
a coil in the housing and configured to convey near-field communications (NFC) signals through the dielectric wall;
a set of one or more magnets disposed around a periphery of the coil and configured to attract an external device through the dielectric wall; and
an antenna that includes first, second, third, and fourth antenna elements configured to concurrently convey a radio-frequency signal with the external device through the dielectric wall, wherein
the first antenna element is configured to convey the radio-frequency signal with a first phase,
the second antenna element is configured to convey the radio-frequency signal with a second phase that is 180 degrees less than the first phase,
the third antenna element is configured to convey the radio-frequency signal with a third phase that is greater than the first phase by a phase shift, and
the fourth antenna element is configured to convey the radio-frequency signal with a fourth phase that is greater than the second phase by the phase shift.

20. The electronic device of claim 19, wherein:
the first antenna element has a central axis in a boresight direction of the first antenna element,
the first antenna element is configured to exhibit a first gain at a first elevation angle that is greater than or equal to 30 degrees from the central axis, and
the second antenna element is configured to exhibit a second gain at a second elevation angle less than the first elevation angle, wherein the first gain is at least 1 dB greater than the second gain.
